(19) United States
(12) Patent Application Publication
(10) Pub. No.: US 2026/0058415 A1
(43) Pub. Date: Feb. 26, 2026

(54) CONNECTOR, CONNECTOR ASSEMBLY, AND CONNECTION DEVICE

(71) Applicant: Panasonic Intellectual Property Management Co., Ltd., Osaka (JP)

(72) Inventor: TAKUYA HAYASHI, Osaka (JP)

(21) Appl. No.: 19/110,039

(22) PCT Filed: Sep. 29, 2023
(86) PCT No.: PCT/JP2023/035656

§ 371 Date: Mar. 7, 2025

(30) Foreign Application Priority Data
Nov. 14, 2022 (JP) 2022-182150

(51) Int. Cl. H01R 13/6585; H01R 12/71; H01R 13/516

(52) U.S. Cl. CPC H01R 13/6585; H01R 12/712; H01R 13/516

(57) ABSTRACT

A connector includes a shield that comes into contact with a mating shield of a mating connector in a fitted state where the connector and the mating connector are fitted to each other. The shield includes an outer wall, an inner wall including an inner facing part, and a coupling part coupling the outer wall and the inner wall. The coupling part includes an inner coupling part connected to the inner facing part. The inner coupling part includes an inner curved part curved and bulging toward an inner side of the connector. A step is formed by a first portion and a second portion on an outer surface of the inner curved part. A part of the first portion is located inside the connector with respect to the second portion.

### TECHNICAL FIELD

The present disclosure generally relates to a connector, a connector assembly, and a connection device, and more particularly to a connector to which a mating connector is fitted, a connector assembly including the connector, and a connection device including the connector.

### BACKGROUND ART

PTL 1 discloses an electric connector set. The electric connector set includes a first connector and a second connector. The first connector is mounted on a first circuit board. The second connector is mounted on a second circuit board and is fitted to the first connector so as to be insertable and removable in the insertion and removal directions.

The first connector includes a first connection terminal, a first high frequency connection terminal, and a first external grounding member. The first high frequency connection terminal transmits a high frequency signal having a higher frequency than the signal transmitted through the first connection terminal. The first external grounding member is a conductor connected to the ground potential and surrounds the first high frequency connection terminal.

The second connector includes a second connection terminal, a second high frequency connection terminal, and a second external grounding member. The second connection terminal is electrically connected to the first connection terminal at the time of fitting. The second high frequency connection terminal is electrically connected to the first high frequency connection terminal at the time of fitting. The second external grounding member is a conductor connected to the ground potential, surrounds the second high frequency connection terminal, and is electrically connected to the first external grounding member at the time of fitting.

When the first connector and the second connector are fitted to each other, the second external grounding member is located inside the first external grounding member in plan view from the insertion and removal directions. The first connection terminal and the second connection terminal are located outside the first external grounding member, and the second external grounding member is circumferentially closed so as to surround the first high frequency connection terminal and the second high frequency connection terminal.

### CITATION LIST

### Patent Literature

PTL 1: International Patent Publication No. 2020/040004

### SUMMARY OF THE INVENTION

In the connector used in the electric connector set of PTL 1, it is desired that a fitted state in which the connecter is fitted to the mating connector is not unintentionally released.

An object of the present disclosure is to provide a connector that easily maintains the fitted state with a mating connector, and a connector assembly and a connection device including the connector.

A connector according to one aspect of the present disclosure is to be fitted to a mating connector having a mating shield. The connector includes a housing, a terminal, and a shield. The terminal is held by the housing. The shield is held by the housing so as to surround the terminal in a circumferential direction. The shield is configured to be in contact with the mating shield in a fitted state in which the connector and the mating connector are fitted. The connector is configured to be connected to the mating connector by moving toward the mating connector. The shield includes an outer wall, an inner wall, and a coupling part. The outer wall includes an outer facing part. The inner wall includes an inner facing part. The inner wall is located inside the connector with respect to the outer wall. The coupling part couples the outer wall and the inner wall. The coupling part includes an inner coupling part connected to the inner facing part, an outer coupling part connected to the outer facing part, and an upper coupling part. The inner coupling part includes an inner curved part curved so as to bulge toward the inside of the connector. The outer coupling part includes an outer curved part curved so as to bulge toward the outside of the connector. the upper coupling part connects the inner coupling part and the outer coupling part. The inner curved part and the outer curved part are connected via the upper coupling part. The outer facing part and the inner facing part face each other with a space therebetween. An outer surface of the inner curved part includes a first portion and a second portion. The second portion is continuous with the first portion. A step is formed by the first portion and the second portion. A part of the first portion protrudes more inward of the connector than the second portion.

A connector assembly according to an aspect of the present disclosure includes the connector and the mating connector.

A connection device according to one aspect of the present disclosure includes the connector and a circuit board to which the connector is connected.

### ADVANTAGEOUS EFFECT OF INVENTION

According to the present disclosure, it is possible to obtain a connector that easily maintains a fitted state with a mating connector, and a connector assembly and a connection device including the connector.

### BRIEF DESCRIPTION OF THE DRAWINGS

FIG. 1 is an exploded perspective view of a connector assembly according to an exemplary embodiment.

FIG. 2 is a top view of the connector assembly in a fitted state.

FIG. 3 is a perspective view of a first connector in the connector assembly.

FIG. 4 is a perspective view of a first housing in the first connector.

FIG. 5 is a perspective view of a first terminal and a first inner shield in the first connector.

FIG. 6 is a perspective view of a first outer shield in the first connector.

FIG. 7 is a top view of a circuit pattern of a first circuit board connected to the first connector.

FIG. 8 is a perspective view of a second housing in the second connector.

FIG. 9 is a perspective view of a second terminal and a second inner shield in the second connector.

FIG. 10 is a perspective view of a second outer shield in the second connector.

FIG. 11 is a perspective view of a main part of the second outer shield.

FIG. 12 is a bottom view of a circuit pattern of a second circuit board connected to the second connector.

FIG. 13A is a sectional view of a main part of a portion corresponding to line A-A in FIG. 1.

FIG. 13B is a sectional view of a main part of a portion corresponding to line B-B in FIG. 1.

FIG. 14 is a sectional view of the connector assembly at a portion corresponding to line XV-XV in FIG. 2 in a state where the connector assembly is disassembled.

FIG. 15 is a sectional view taken along line XV-XV in FIG. 2.

FIG. 16 is a sectional view taken along line XVI-XVI in FIG. 2.

FIG. 17 is a sectional view taken along line XVII-XVII in FIG. 2.

FIG. 18 is a sectional view taken along line XVIII-XVIII in FIG. 2.

FIG. 19 is a sectional view taken along line XIX-XIX in FIG. 2.

FIG. 20 is a perspective view of a first outer shield in a first connector of a connector assembly according to a first modification.

FIG. 21 is a perspective view of a second outer shield in a second connector of a connector assembly according to a second modification.

### DESCRIPTION OF EMBODIMENT

Hereinafter, a connector, a connector assembly, and a connection device according to an exemplary embodiment will be described with reference to the drawings. The following exemplary embodiment is merely one of various exemplary embodiments of the present disclosure. The following exemplary embodiment can be variously changed in accordance with a design and the like as long as the object of the present disclosure can be achieved. The drawings described in the following exemplary embodiment are schematic representations, and ratios of sizes and thicknesses of components in the drawings do not necessarily need to reflect actual dimensional ratio.

### (1) Overview

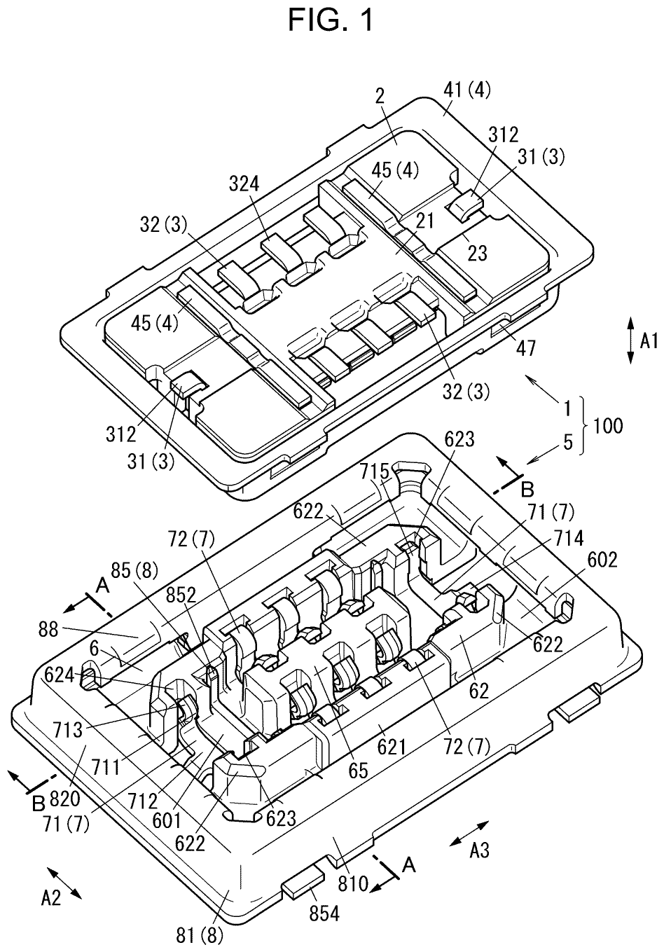

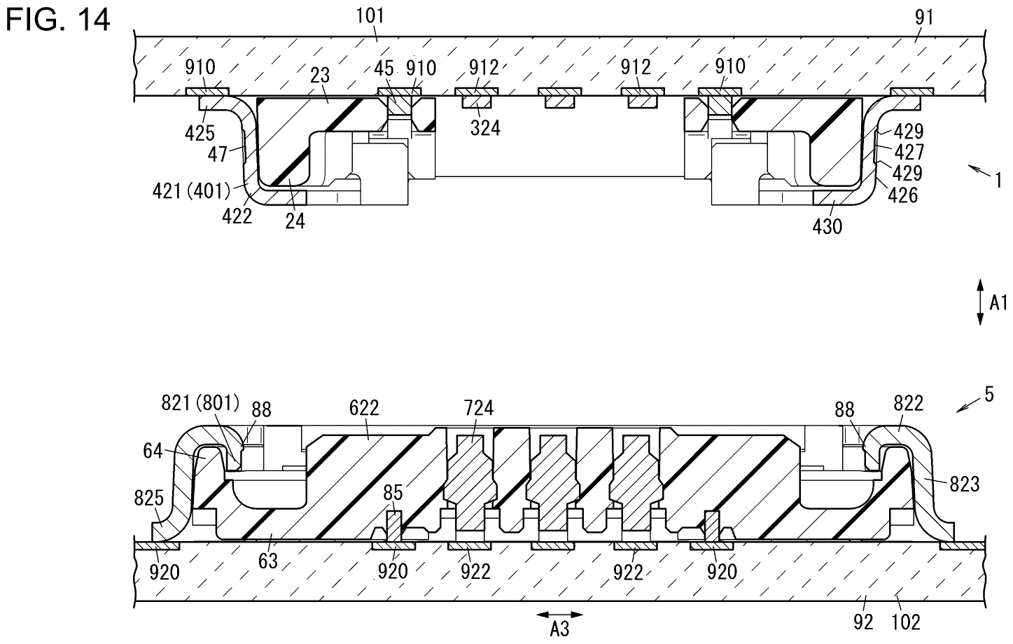

As illustrated in FIG. 1, connector assembly 100 of the present exemplary embodiment includes first connector 1 (mating connector) and second connector 5 (connector). Connector assembly 100 is used to electrically connect a plurality of circuit boards mounted on a mobile terminal such as a smartphone. First connector 1 is attached to, for example, first circuit board 91 (see FIGS. 14 to 19) such as a printed wiring board or a flexible printed wiring board in an antenna module (AiP; Antenna in Package). in

[symbol]

Second connector 5 is attached to, for example, second circuit board 92 (see FIGS. 14 to 19) such as a printed wiring board or a flexible printed wiring board. It is not intended to limit the use of connector assembly 100, and connector assembly 100 may be used for, for example, an electronic device other than a mobile terminal, such as a camera module. The application of connector assembly 100 is not limited to the application of electrically connecting a plurality of circuit boards, and the application may be, for example, an application of electrically connecting a plurality of components such as between a circuit board and a display or between a circuit board and a battery. In the drawings other than FIGS. 14 to 19, illustration of first circuit board 91 and second circuit board 92 is omitted for convenience.

Second connector 5 is a connector of the present disclosure. Second connector 5 is fitted to first connector 1. Thus, first connector 1 is a mating connector of second connector 5 (connector).

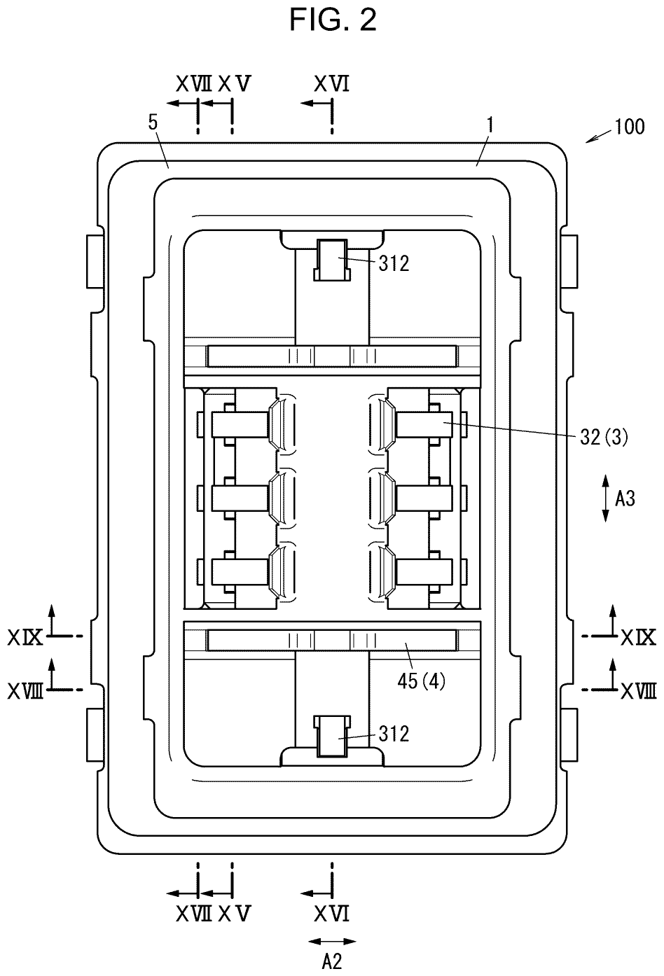

As illustrated in FIG. 1, second connector 5 is configured to be fitted to first connector 1 by moving in one direction in first axis A1 with respect to first connector 1 toward first connector 1. Hereinafter, the directions in which first connector 1 and second connector 5 are fitted (directions along first axis A1) may be referred to as up-down directions. Hereinafter, when first connector 1 and second connector 5 are fitted to each other along the up-down directions, the side on which first connector 1 is located may be referred to as “up”, and the side on which second connector 5 is located may be referred to as “down”. That is, second connector 5 is configured to be connected to first connector 1 by moving upward along first axis A1 with respect to first connector 1 toward first connector 1. However, the definition of these directions is not intended to limit the use form of connector assembly 100. Hereinafter, a state in which first connector 1 and second connector 5 are fitted to each other (see FIG. 2) is referred to as “fitted state”.

Hereinafter, two axes orthogonal to first axis A1 are referred to as second axis A2 and third axis A3. As illustrated in FIG. 1, second axis A2 is an axis along a short direction of connector assembly 100. Third axis A3 is an axis along a long direction of connector assembly 100.

As illustrated in FIG. 1, second connector 5 includes a housing (second housing 6), a terminal (second terminal 7), and a shield (second outer shield 81). Second terminal 7 is held by second housing 6. Second outer shield 81 is held by second housing 6 so as to surround second terminal 7 in the circumferential direction. In the present disclosure, the “circumferential direction” means a direction along the outer periphery of the connector. For example, when second lateral shield 810 of second outer shield 81 is focused, the circumferential direction is a direction along third axis A3. When second longitudinal shield 820 of second outer shield 81 is focused, the circumferential direction is a direction along second axis A2.

As illustrated in FIGS. 1, 10, 13A, and 13B, second outer shield 81 includes inner wall 801, coupling part 802, and outer wall 803. Outer wall 803 includes outer facing part 895. Inner wall 801 includes inner facing part 865. Inner wall 801 is located inside second connector 5 with respect to outer wall 803. In the present disclosure, the “inside of the connector” means a side close to the center of the connector when viewed along first axis A1. Coupling part 802 couples outer wall 803 and inner wall 801.

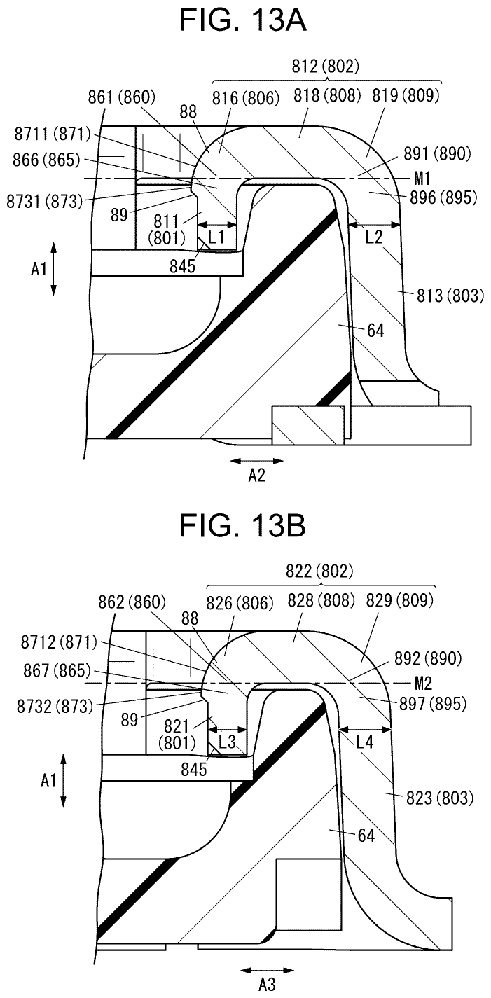

As illustrated in FIGS. 13A and 13B, coupling part 802 includes inner coupling part 806, outer coupling part 809, and upper coupling part 808. Inner coupling part 806 is connected to inner facing part 865. Inner coupling part 806 includes inner curved part 860 curved so as to bulge toward the inside of second connector 5. Outer coupling part 809 is connected to outer mating part 895. Outer coupling part 809 includes outer curved part 890 curved so as to bulge toward the outside of second connector 5. Upper coupling part 808 connects inner coupling part 806 and outer coupling part 809. Inner curved part 860 and outer curved part 890 are disposed via upper coupling part 808 in an axis (second axis A2 or third axis A3) orthogonal to first axis A1. Outer facing part 895 and inner facing part 865 face each other with a space therebetween in an axis (second axis A2 or third axis A3) orthogonal to first axis A1.

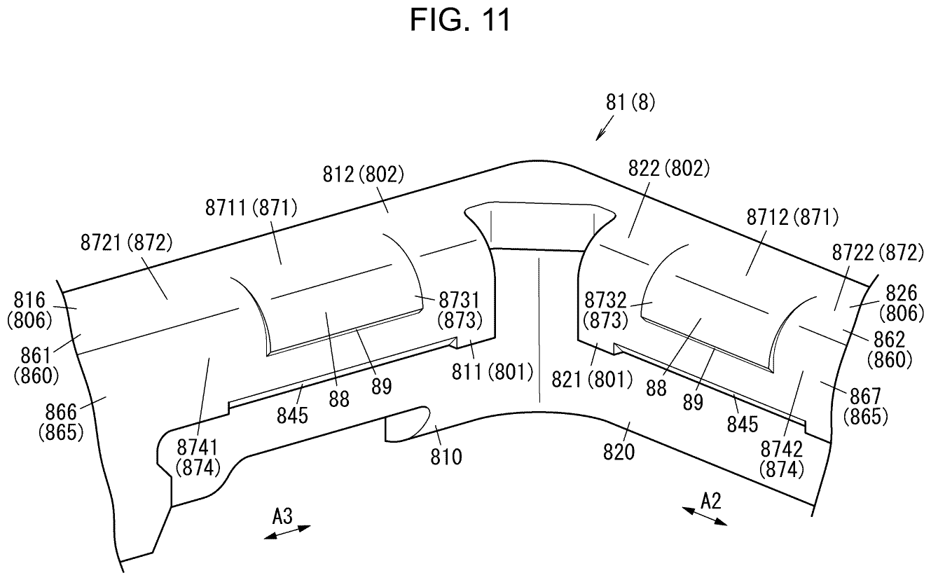

As illustrated in FIG. 11, the outer surface of inner curved part 860 includes first portion 871 and second portion 872. In the present disclosure, the “outer surface” of the shield held by the housing means one of a surface away from the housing, out of a surface close to the housing and the surface away from the housing. Second portion 872 is continuous with first portion 871 via a step in the circumferential direction. First portion 871 protrudes more inward of second connector 5 than second portion 872.

In second connector 5 (connector) of the present exemplary embodiment, the outer surface of inner curved part 860 includes second portion 872 and first portion 871 protruding more inward of second connector 5 than second portion 872. Consequently, in second outer shield 81 (shield), protrusion 88 is formed in a portion corresponding to first portion 871. Thus, in second connector 5 of the present exemplary embodiment, for example, by hooking protrusion 88 to a recess of first outer shield 41 (mating shield) included in first connector 1 (mating connector), it is possible to prevent the fitted state from being unintentionally released. That is, second connector 5 (connector) of the present exemplary embodiment has an advantage that it is easy to maintain the fitted state with first connector 1 (mating connector).

In second outer shield 81 of second connector 5 of the present exemplary embodiment, at least a part of protrusion 88 is formed in inner curved part 860 (a portion corresponding to first portion 871). Here, for example, when the protrusion is formed only on a wall part (for example, inner wall 801) that is not curved, it is necessary to form the protrusion by cutting and raising a part of the wall part or joining another member to the surface of the wall part by, for example, welding or the like. When the protrusion is formed by cutting and raising, a gap (space) is formed between the protrusion and a portion around the protrusion, and the shielding property may deteriorate. When the protrusion is formed by joining another member, steps such as preparation and joining of another member are required. On the other hand, when at least a part of protrusion 88 is formed in inner curved part 860 as in second outer shield 81 of the present exemplary embodiment, protrusion 88 can be formed by rolling a portion other than protrusion 88 and including inner curved part 860. This can prevent a decrease in the shielding property and simplify the process. In addition, since at least a part of protrusion 88 is formed in inner curved part 860, the dimension of wall part in first axis A1 can be reduced as compared with a case where the entire protrusion 88 is formed in the wall part (for example, inner wall 801), and the height of connector assembly 100 in first axis A1 in a state where first connector 1 and second connector 5 are fitted to each other can be reduced.

### (2) Details

Hereinafter, connector assembly 100, first connector 1 (mating connector), second connector 5 (connector), first connection device 101, and second connection device 102 (connection device) of the present exemplary embodiment will be described in more detail with reference to the drawings.

### (2.1) First Connector

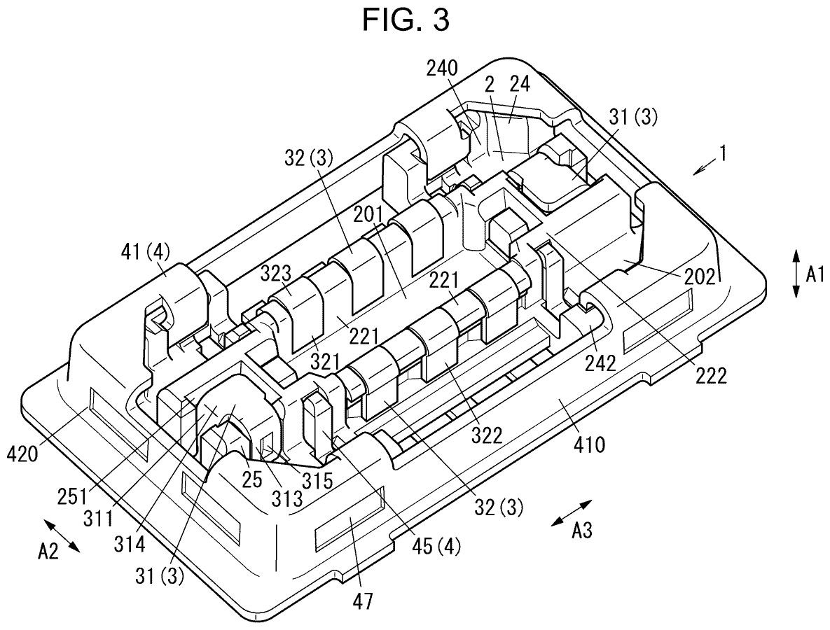

First connector 1 is a header (male connector), including first housing 2, a plurality of (here, eight) first terminals 3, and first shield 4 as illustrated in FIGS. 3 to 6. In FIGS. 3 to 6, first connector 1 is illustrated upside down for convenience.

### (2.1.1) First Housing

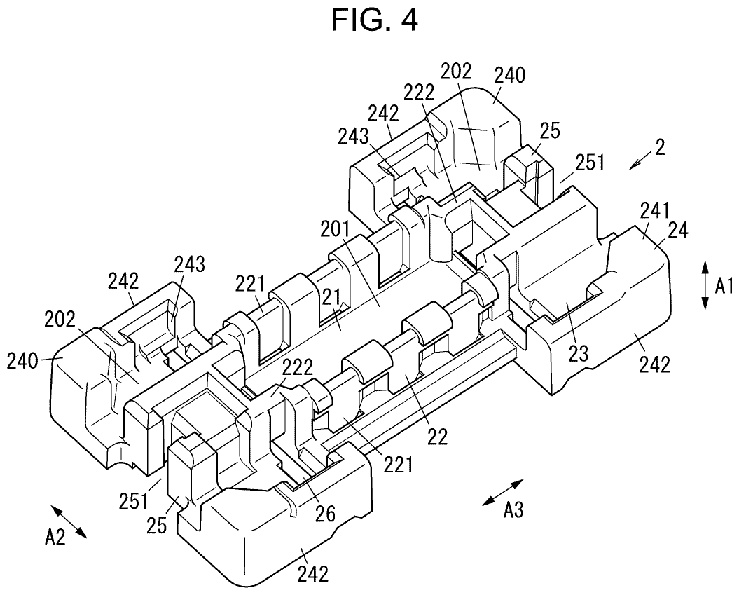

As illustrated in FIG. 4, first housing 2 is made of an insulating resin material, and is formed in a flat shape elongated in third axis A3. In first housing 2, both sides in second axis A2 in the central portion in third axis A3 are cut out in a substantially rectangular shape as viewed from first axis A1. First housing 2 is formed in a substantially H shape as viewed from first axis A1 (hereinafter, also referred to as “plan view”).

As illustrated in FIG. 4, first housing 2 includes first inner bottom wall 21, first inner peripheral wall 22, first outer bottom wall 23, first outer peripheral wall 24, and a pair of holding walls 25. First inner bottom wall 21, first inner peripheral wall 22, first outer bottom wall 23, first outer peripheral wall 24, and the pair of holding walls 25 are integrally formed.

First inner bottom wall 21 has a rectangular plate shape elongated along third axis A3.

First inner peripheral wall 22 protrudes downward (upward in FIG. 4) from the peripheral edge of first inner bottom wall 21 and has a rectangular frame shape in plan view. Specifically, first inner peripheral wall 22 includes a pair of first lateral inner walls 221 and a pair of first longitudinal inner walls 222. The pair of first lateral inner walls 221 is a pair of walls of first inner peripheral wall 22 elongated in third axis A3. The pair of first longitudinal inner walls 222 is a pair of walls of first inner peripheral wall 22 elongated in second axis A2. The portion surrounded by the inner bottom surface of first inner bottom wall 21 and the inner side surface of first inner peripheral wall 22 constitutes first fitting recess 201 to which second connector 5 is fitted. Specifically, base 65 of second connector 5 is fitted into first fitting recess 201.

First outer bottom wall 23 includes four partial bottom walls extending in a rectangular shape from the four corners of first inner bottom wall 21 toward the outside of second axis A2 and third axis A3.

First outer peripheral wall 24 protrudes downward from the peripheral edge of first outer bottom wall 23 so as to surround first inner peripheral wall 22. First outer peripheral wall 24 includes four first outer walls 240. Four first outer walls 240 correspond one-to-one to the four partial bottom walls of first outer bottom wall 23. Each of four first outer walls 240 has an L shape in plan view. Specifically, each of four first outer walls 240 includes first longitudinal outer wall 241 and first lateral outer wall 242. First longitudinal outer wall 241 is a wall of first outer wall 240 elongated in second axis A2. First lateral outer wall 242 is a wall of first outer wall 240 elongated in third axis A3. Each of four first outer walls 240 is formed along the outer peripheral edge of the corresponding partial bottom wall.

The pair of holding walls 25 is formed integrally with the pair of first longitudinal inner walls 222 of first inner peripheral wall 22 at both ends of first inner peripheral wall 22 in third axis A3. Each of the pair of holding walls 25 has a rectangular parallelepiped shape. In each of the pair of holding walls 25, recess 251 in which first specific terminal 31 is disposed is formed over the lower surface thereof, the outer surface in third axis A3, and a surface on one side in second axis A2.

In second axis A2, both side surfaces in second axis A2 in each of the pair of holding walls 25 face the inner side surfaces of first lateral outer walls 242 of two first outer walls 240, respectively. The portion surrounded by the side surface of holding wall 25, the inner bottom surface of first outer bottom wall 23, and the inner side surface of first outer peripheral wall 24 constitutes second fitting recess 202 to which second connector 5 is fitted. Specifically, second inner peripheral wall 62 of second connector 5 is fitted into second fitting recess 202.

First housing 2 holds the plurality of first terminals 3 and first shield 4.

In the present exemplary embodiment, some (six) first terminals 3 (first connection terminals 32) of the plurality of (eight) first terminals 3 are provided on the pair of first lateral inner walls 221. Specifically, three first connection terminals 32 are held on each of the pair of first lateral inner walls 221. First connection terminal 32 is accommodated in a recess provided in first lateral inner wall 221. Remaining first terminals 3 (first specific terminals 31) of the plurality of (eight) first terminals 3 are accommodated in recesses 251 formed in the pair of holding walls 25.

In the present exemplary embodiment, first outer shield 41 sandwiches first outer peripheral wall 24. In the present exemplary embodiment, first inner shield 45 of first shield 4 is accommodated in groove hole 26 formed in first housing 2.

### (2.1.2) First Terminal

First terminal 3 (mating terminal) is a signal transmission terminal, and is formed by bending a band-shaped metal plate. First terminal 3 is plated with gold.

The plurality of first terminals 3 include one or more first specific terminals 31. The plurality of first terminals 3 include one or more terminals (first connection terminals 32) other than first specific terminal 31. Here, among eight first terminals 3, two are first specific terminals 31, and the remaining six are first connection terminals 32.

Two first specific terminals 31 are disposed on both sides in third axis A3 in first connector 1. Two first specific terminals 31 are respectively held by the pair of holding walls 25.

Six first connection terminals 32 are disposed side by side in third axis A3 in a region between two first specific terminals 31 in third axis A3 so as to be divided into three on each side in second axis A2. Three of six first connection terminals 32 are held on each of the pair of first lateral inner walls 221.

For example, first specific terminal 31 is a terminal for transmitting a relatively high-frequency signal. Two first specific terminals 31 have the same shape. For example, a signal current flowing from first circuit board 91 to second circuit board 92 flows through one of two first specific terminals 31. A signal current from second circuit board 92 to first circuit board 91 flows through the other of two first specific terminals 31.

First connection terminal 32 is a terminal for transmitting a relatively low-frequency signal. Some or all of the plurality of (for example, six) first connection terminals 32 may be terminals that transmit power. Here, six first connection terminals 32 have the same shape. First connection terminal 32 may include terminals having different shapes.

### (2.1.2.1) First Specific Terminal

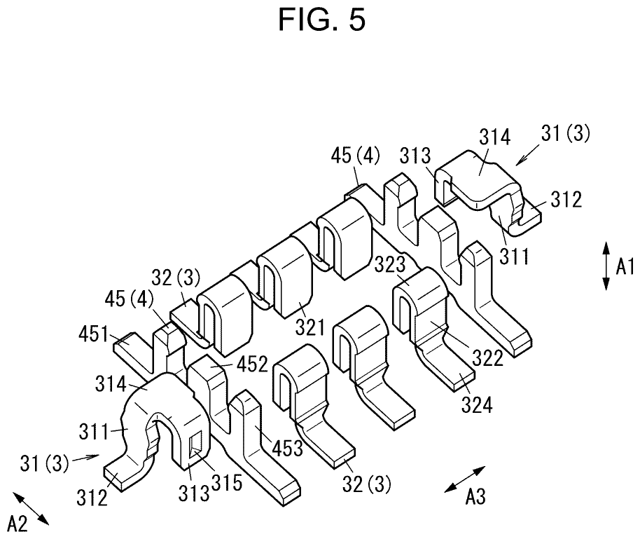

As illustrated in FIG. 5, first specific terminal 31 includes holding piece 311, terminal piece 312, first contact piece 313, and coupling piece 314, which are integrally formed.

Holding piece 311 is a portion mainly held by first housing 2 in first specific terminal 31. As illustrated in FIG. 5, holding piece 311 has a substantially rectangular flat plate shape having a thickness in third axis A3. A pair of holding protrusions for first housing 2 to hold first specific terminal 31 is formed on both end surfaces of holding piece 311 on both sides in second axis A2. Holding piece 311 protrudes upward in first axis A1 from a side end (an outer end in third axis A3) of coupling piece 314.

Terminal piece 312 has a flat plate shape having a thickness in first axis A1. Terminal piece 312 protrudes along third axis A3 from the upper end surface of holding piece 311. The width dimension (dimension in second axis A2) of terminal piece 312 is smaller by one step than the width dimension of the portion where the holding protrusion is formed in holding piece 311. As illustrated in FIG. 1, one surface (upper surface) of terminal piece 312 is exposed to the upper surface of first outer bottom wall 23 of first housing 2.

First contact piece 313 has a substantially rectangular flat plate shape having a thickness in second axis A2. First contact piece 313 protrudes upward in first axis A1 from one end in second axis A2 of coupling piece 314. As illustrated in FIG. 3, the outer surface of first contact piece 313 in second axis A2 is exposed to second fitting recess 202 of first housing 2. First contact piece 313 includes first contact point 315 (recess) configured to be in contact with second specific terminal 71. First contact point 315 is on an outer surface of first contact piece 313 exposed to second fitting recess 202.

Coupling piece 314 has a substantially rectangular flat plate shape having a thickness in first axis A1. Coupling piece 314 couples holding piece 311 and first contact piece 313. Specifically, holding piece 311 is connected to the outer end of coupling piece 314 in third axis A3, and terminal piece 312 is connected to one side end of coupling piece 314 in second axis A2.

For example, first specific terminal 31 is held by first housing 2 by press-fitting holding piece 311 into the groove on the outer side of third axis A3 of recess 251 of holding wall 25 of first housing 2 (see FIG. 3). In a state where first connector 1 is not fitted to the second connector, first contact piece 313 may be separated from holding wall 25 (the bottom surface of the groove of recess 251) of first housing 2 in second axis A2.

As illustrated in FIG. 3, in two first specific terminals 31, directions in which first contact piece 313 extends from coupling piece 314 are opposite to each other in second axis A2. Two first specific terminals 31 are disposed so as to have rotational symmetry with respect to the center of first housing 2 as viewed along first axis A1.

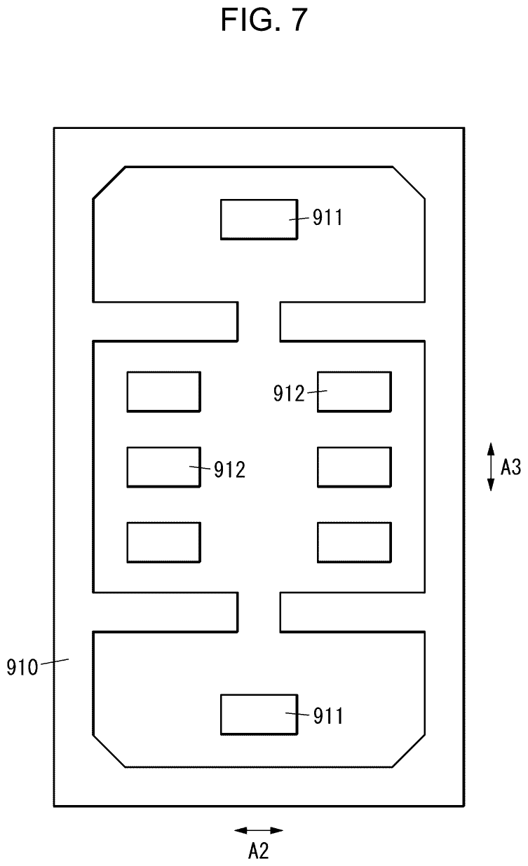

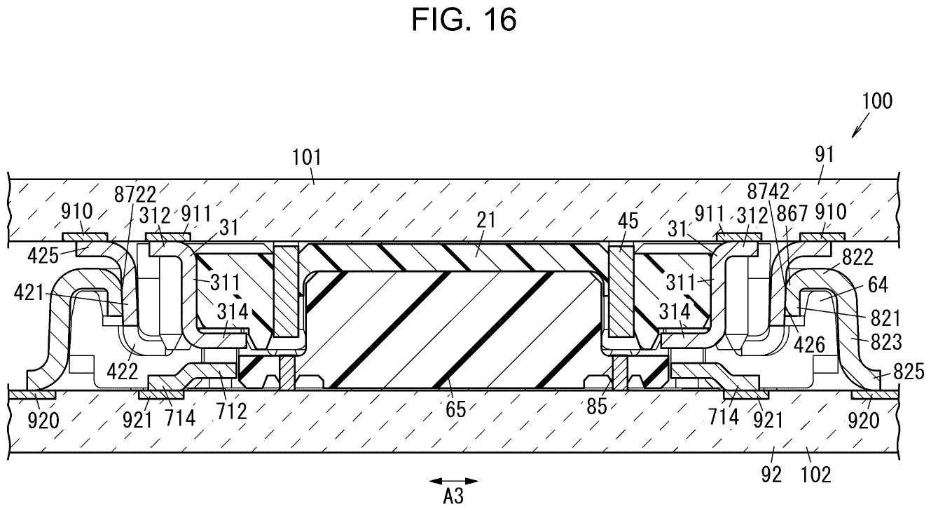

As illustrated in FIG. 16, first specific terminal 31 is connected to conductor pattern 911 (see FIG. 7) of first circuit board 91. Specifically, first specific terminal 31 is joined to conductor pattern 911 of first circuit board 91 by solder on the upper surface (surface intersecting the thickness direction) of terminal piece 312.

### (2.1.2.2) First Connection Terminal

As illustrated in FIG. 5, first connection terminal 32 includes extending piece 321, contact piece 322, connecting piece 323, and terminal piece 324, which are integrally formed. Extending piece 321 and contact piece 322 have contact points that come into contact with second connection terminal 72 in the fitted state.

Extending piece 321 has a substantially rectangular flat plate shape having a thickness in second axis A2. As illustrated in FIG. 3, the inner surface of extending piece 321 in second axis A2 is exposed to first fitting recess 201 of first housing 2.

Contact piece 322 has a substantially rectangular flat plate shape having a thickness in second axis A2. As illustrated in FIG. 3, the outer surface of contact piece 322 in second axis A2 is exposed to second fitting recess 202 of first housing 2.

Connecting piece 323 is curved in a U shape so as to connect the lower end of extending piece 321 and the lower end of contact piece 322. The lower surface of connecting piece 323 is exposed to the lower surface of first lateral inner wall 221 of first housing 2.

Terminal piece 324 has a substantially rectangular flat plate shape having a thickness in first axis A1. Terminal piece 324 protrudes outward along second axis A2 from the upper end of contact piece 322. As illustrated in FIG. 1, the upper surface of terminal piece 324 is exposed to the upper surface of first housing 2.

First connection terminal 32 is formed integrally with first housing 2 by, for example, simultaneous molding.

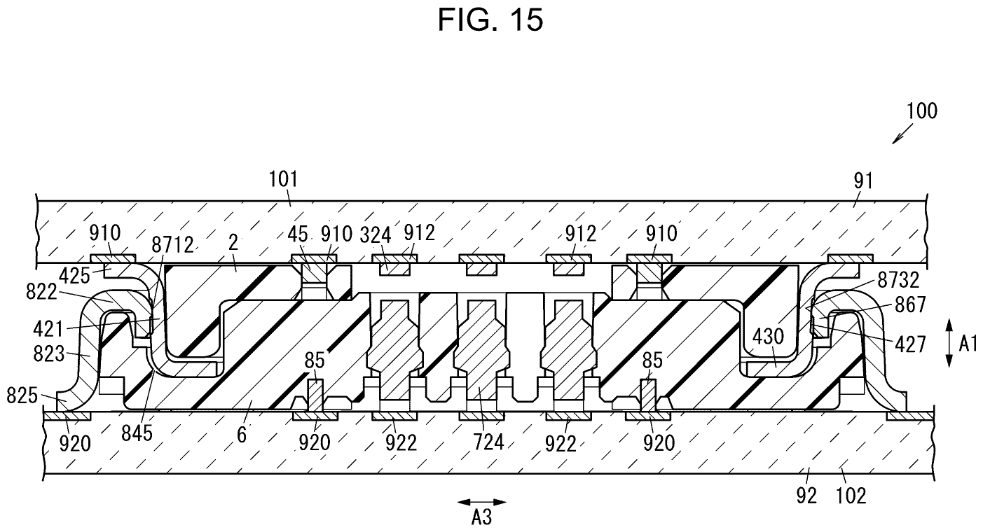

As illustrated in FIGS. 14 and 15, first connection terminal 32 is connected to conductor pattern 912 of first circuit board 91 (a conductor pattern different from conductor pattern 911 to which first specific terminal 31 is connected; see FIG. 7). Specifically, first connection terminal 32 is connected to conductor pattern 912 of first circuit board 91 on the upper surface (surface intersecting the thickness direction) of terminal piece 324.

### (2.1.3) First Shield

First shield 4 is an electromagnetic shield for shielding electromagnetic waves. First shield 4 reduces the influence of external noise (electromagnetic wave) on the signal current flowing through first terminal 3 and second terminal 7. In addition, the first shield 4 reduces an influence of noise (electromagnetic wave) caused by the signal current flowing through first terminal 3 and second terminal 7 on an external electric device or the like.

As illustrated in FIG. 3, first shield 4 surrounds at least one of the plurality of first terminals 3. First shield 4 surrounds at least first specific terminal 31 among the plurality of first terminals 3. Here, first shield 4 surrounds the plurality of first specific terminals 31 and surrounds the plurality of first connection terminals 32.

The material of first shield 4 is selected from, for example, copper alloys such as phosphor bronze and corson copper, stainless steel, nickel silver, and the like.

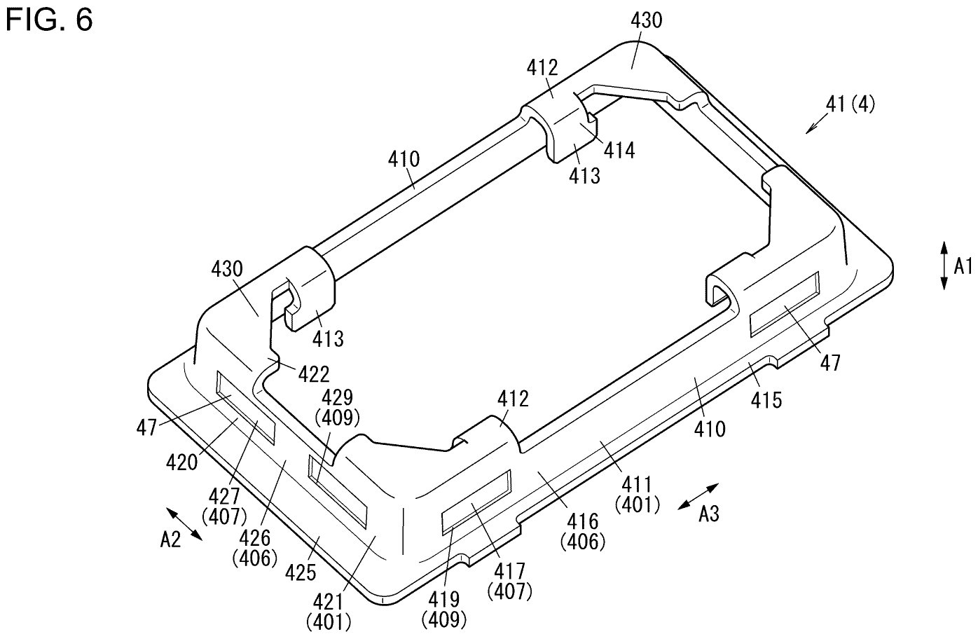

As illustrated in FIGS. 5 and 6, first shield 4 includes first outer shield 41 and first inner shield 45.

### (2.1.3.1) First Outer Shield

As illustrated in FIG. 3, first outer shield 41 is held by first outer peripheral wall 24 of first housing 2. First outer shield 41 surrounds the plurality of first terminals 3.

As illustrated in FIG. 6, first outer shield 41 includes a pair of first lateral shields 410 and a pair of first longitudinal shields 420.

The pair of first lateral shields 410 extends in third axis A3. As illustrated in FIG. 3, first lateral shield 410 covers the outer side surface of first lateral outer wall 240 in first outer wall 242. Each of the pair of first lateral shields 410 is provided across two adjacent first lateral outer walls 242 so as to bridge a gap between two adjacent first lateral outer walls 242. First lateral shield 410 covers at least a part of the lower surface of first lateral outer wall 242.

The pair of first longitudinal shields 420 extends in second axis A2. As illustrated in FIG. 3, first longitudinal shield 420 covers the outer side surface of the first longitudinal outer wall 240 in the first outer wall 241. Each of the pair of first longitudinal shields 420 is provided across two adjacent first longitudinal outer walls 241 so as to bridge a gap between two adjacent first longitudinal outer walls 241. First longitudinal shield 420 covers at least a part of the lower surface of first longitudinal outer wall 241.

As illustrated in FIG. 6, each of the pair of first lateral shields 410 is connected to both of the pair of first longitudinal shields 420. Thus, first outer shield 41 is formed in a quadrangular frame shape in plan view. First outer shield 41 (the pair of first lateral shields 410 and the pair of first longitudinal shields 420) is formed by, for example, drawing. The end of first lateral shield 410 in third axis A3 and the end of first longitudinal shield 420 in second axis A2 are connected without any joint (seamlessly). Thus, first outer shield 41 seamlessly surrounds first terminal 3 in the circumferential direction.

As illustrated in FIG. 6, first lateral shield 410 includes first side wall 411, first coupling part 412, curved part 414, third side wall 413, and junction 415.

First side wall 411 has a substantially rectangular flat plate shape having a thickness in second axis A2. First side wall 411 extends in first axis A1 (up-down directions). First side wall 411 extends in third axis A3.

First coupling part 412 is connected to the lower end of first side wall 411. First coupling part 412 is curved from the lower end of first side wall 411 toward the inside of second axis A2. Specifically, first coupling part 412 is curved in an L shape when viewed from third axis A3. First lateral shield 410 has at least one (here, a plurality of) first coupling parts 412. The plurality of first coupling parts 412 are arranged apart from each other in second axis A2. In first lateral shield 410, one first coupling part 412 is provided at each end in third axis A3.

Curved part 414 is curved upward from the tip of first coupling part 412. Curved part 414 is provided in an inner portion of first coupling part 412 in third axis A3. First coupling part 412 and curved part 414 are curved in a U shape so as to protrude downward of first axis A1 when viewed from third axis A3.

Third side wall 413 has a plate shape having a thickness in second axis A2. Third side wall 413 is coupled to the tip of curved part 414. Third side wall 413 faces first side wall 411 in second axis A2. Third side wall 413 is located inside first connector 1 with respect to first side wall 411. On an end surface on one side of third side wall 413 in third axis A3, a holding protrusion for first housing 2 to hold first lateral shield 410 is formed. Four third side walls 413 are respectively inserted (press-fitted) into recessed parts 243 formed in the inner surfaces of four first lateral outer walls 242 of first outer peripheral wall 24 in first housing 2, whereby first outer shield 41 is held by first housing 2.

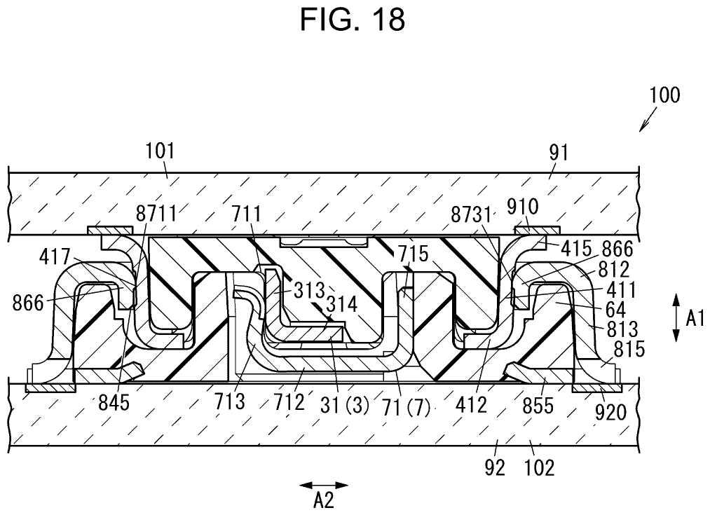

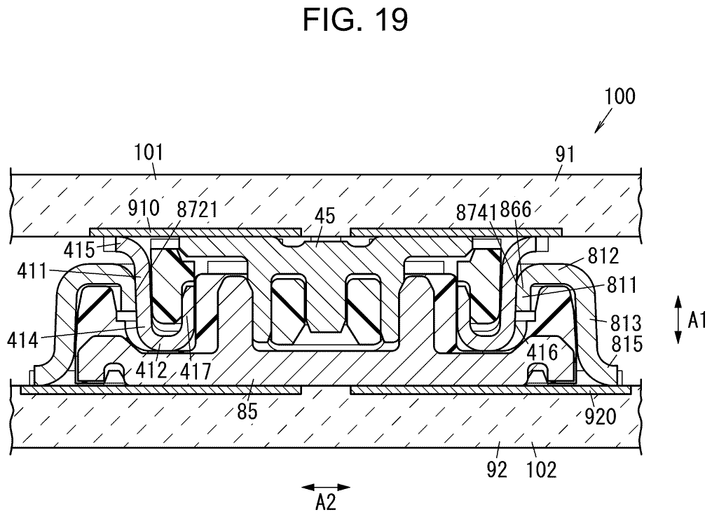

Junction 415 is coupled to the upper end of first side wall 411. Junction 415 is curved from the upper end of first side wall 411 to the outside of second axis A2 and extends along second axis A2. As illustrated in FIGS. 18 and 19, the upper surface of junction 415 is connected to ground pattern 910 (see FIG. 7) of first circuit board 91.

As illustrated in FIG. 6, first lateral shield 410 has recessed part 47 on its outer surface. More specifically, in first lateral shield 410, recessed part 47 recessed in a rectangular shape is formed on the outer surface of first side wall 411. Recessed parts 47 are formed one by one in both ends (portions where first coupling parts 412 are formed) of first side wall 411 in third axis A3. In this manner, the outer surface of first side wall 411 of first lateral shield 410 of first outer shield 41 has reference surface 416 (flat surface) and recessed surface 417 depressed from reference surface 416.

As illustrated in FIG. 6, reference surface 416 and recessed surface 417 are connected by inclined surface 419 at a peripheral edge of recessed surface 417. Recessed part 47 has a tray shape inclined such that edge portions (four sides) spread outward.

As illustrated in FIG. 6, first longitudinal shield 420 includes first side wall 421, first coupling part 422, and junction 425.

First side wall 421 has a substantially rectangular flat plate shape having a thickness in third axis A3. First side wall 421 extends in first axis A1 (up-down directions). First side wall 421 extends in second axis A2. First side wall 421 of first longitudinal shield 420 is connected to first side wall 411 of first lateral shield 410 without any joint (seamlessly).

First coupling part 422 is coupled to the lower end of first side wall 421. First coupling part 422 is curved from the lower end of first side wall 421 toward the inside of third axis A3. Specifically, first coupling part 422 is curved in an L shape as viewed from second axis A2. First longitudinal shield 420 has at least one (here, a plurality of) first coupling parts 422. The plurality of first coupling parts 422 are arranged apart from each other in second axis A2. In first longitudinal shield 420, one first coupling part 422 is provided at both ends in second axis A2. First coupling part 422 of first longitudinal shield 420 is connected to first coupling part 412 of first lateral shield 410 without any joint (seamlessly).

Junction 425 is coupled to the upper end of first side wall 421. Junction 425 is curved from the upper end of first side wall 421 to the outside of third axis A3 and extends along third axis A3. As illustrated in FIGS. 14 to 17, the upper surface of junction 425 is connected to ground pattern 910 (see FIG. 7) of first circuit board 91. Junction 425 of first longitudinal shield 420 is connected to junction 415 of first lateral shield 410 without any joint (seamlessly).

As illustrated in FIG. 6, first outer shield 41 further includes connection 430. Connection 430 has a plate shape having a thickness in first axis A1. Connection 430 has a triangular shape as viewed along first axis A1. Connection 430 is provided at a portion where first lateral shield 410 and first longitudinal shield 420 are connected, and connects a lower end of one end of first lateral shield 410 in third axis A3 and a lower end of one end of first longitudinal shield 420 in second axis A2.

First longitudinal shield 420 is held by first housing 2 together with first lateral shield 410.

As illustrated in FIG. 3, in third axis A3, the outer side surface of holding piece 311 of first specific terminal 31 and the central portion of first side wall 421 of the longitudinal shield 420 face each other. The dimension of first side wall 421 of first longitudinal shield 420 in second axis A2 is larger than the dimension of first specific terminal 31 in second axis A2. When viewed from third axis A3, entire first specific terminal 31 is included in first side wall 421. In the present exemplary embodiment, first side wall 421 is parallel to holding piece 311 of first specific terminal 31.

As illustrated in FIG. 6, first longitudinal shield 420 has recessed part 47 on its outer surface. More specifically, in first longitudinal shield 420, recessed part 47 recessed in a rectangular shape is formed on the outer surface of first side wall 421. One recessed part 47 is formed on each of one side and the other side from the center of first side wall 421 in second axis A2. In this manner, the outer surface of first side wall 421 of first longitudinal shield 420 of first outer shield 41 has reference surface 426 (flat surface) and recessed surface 427 depressed from reference surface 426.

As illustrated in FIGS. 6 and 14, reference surface 426 and recessed surface 427 are connected by inclined surface 429 at a peripheral edge of recessed surface 427. Recessed part 47 has a tray shape inclined such that edge portions (four sides) spread outward.

In this manner, the mating shield (first outer shield 41) has recessed part 47 on the outer surface thereof. For convenience, when first side walls 411 and 421 are referred to as first side wall 401 without distinction, recessed part 47 recessed in a rectangular shape is formed on the outer surface of first side wall 401 in first outer shield 41. When reference surfaces 416 and 426 are referred to as reference surface 406 without distinction, and recessed surfaces 417 and 427 are referred to as recessed surface 407 without distinction, first outer shield 41 has an outer wall (first side wall 401), and the outer surface of the outer wall has reference surface 406 (flat surface) and recessed surface 407 depressed from reference surface 406. When inclined surfaces 419 and 429 are referred to as inclined surface 409 without distinction, recessed surface 407 is connected to reference surface 406 via inclined surface 409.

### (2.1.3.2) First Inner Shield

First inner shield 45 is disposed between two first terminal 3 of the plurality of first terminals 3. Here, first inner shield 45 is disposed between first specific terminal 31 and first connection terminal 32.

As illustrated in FIGS. 3 and 5, in the present exemplary embodiment, first shield 4 includes two first inner shields 45. Two first inner shields 45 are disposed side by side in third axis A3 so as to partition between one first specific terminal 31 and the plurality of (six) first connection terminals 32 and between the plurality of first specific terminal 32 and another first connection terminals 31.

In this manner, since first inner shield 45 is disposed between two first specific terminals 31, it is possible to reduce the influence of noise caused by the signal current flowing through one first specific terminal 31 on the signal current flowing through the other first specific terminal 31 and first connection terminal 32. That is, insulation (isolation) between two first specific terminals 31 can be improved.

As illustrated in FIG. 5, first inner shield 45 includes main piece 451, facing piece 452, and a pair of support pieces 453.

Main piece 451 has a thickness in third axis A3 and has a rectangular plate shape elongated in second axis A2. Facing piece 452 has a thickness in third axis A3 and has a plate shape extending downward from the lower end surface in the central portion of main piece 451 in second axis A2. The pair of support pieces 453 has a plate shape extending downward from both sides of facing piece 452 in second axis A2 on the lower end surface of main piece 451.

As illustrated in FIGS. 3 and 16, first inner shield 45 is fixed to first housing 2. Facing piece 452 and the pair of support pieces 453 are accommodated in a groove formed in the upper surface of first longitudinal inner wall 222. The inner surface of facing piece 452 in third axis A3 is exposed to first fitting recess 201. The outer surface of each of the pair of support pieces 453 in second axis A2 is exposed to second fitting recess 202. A part of the lower surface of main piece 451 outside with respect to support piece 453 is exposed to second fitting recess 202.

Here, in a state where first shield 4 is not connected to ground pattern 910 of first circuit board 91, first outer shield 41 and first inner shield 45 are separated from each other and are not electrically connected to each other.

### (2.2) Second Connector

Second connector 5 is a socket (female connector), including second housing 6, a plurality of (here, eight) second terminals 7, and second shield 8 as illustrated in FIGS. 1 and 8 to 10.

### (2.2.1) Second Housing

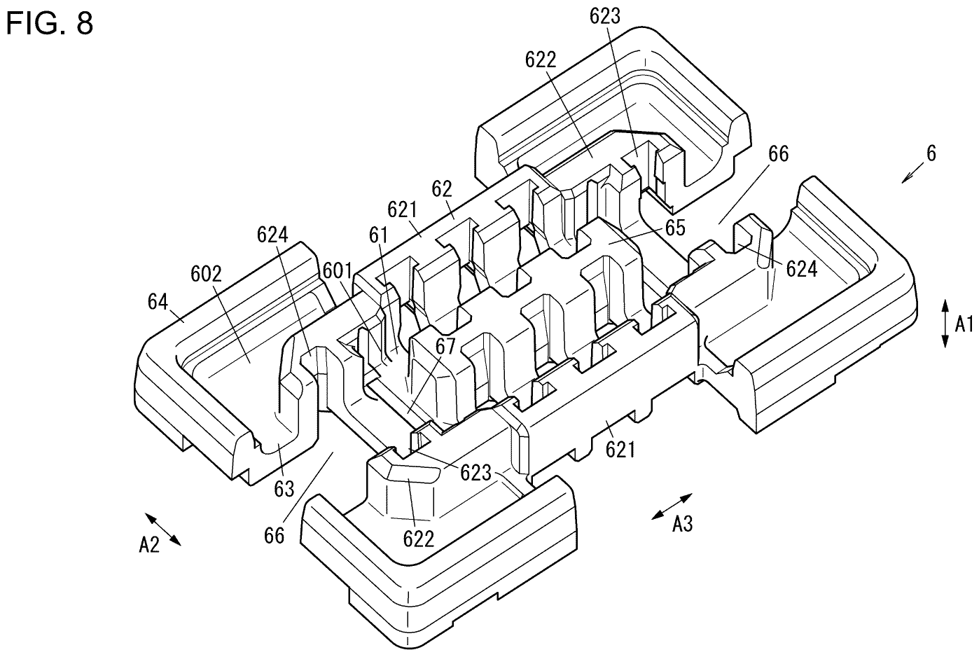

As illustrated in FIG. 8, second housing 6 is made of an insulating resin material and is formed in a flat substantially rectangular parallelepiped shape that is long in third axis A3. In second housing 6, both sides in second axis A2 in the central portion in third axis A3 are cut out in a substantially rectangular shape as viewed from first axis A1. In second housing 6, both sides in third axis A3 in the central portion in second axis A2 are cut out in a substantially rectangular shape as viewed from first axis A1.

As illustrated in FIG. 8, second housing 6 includes second inner bottom wall 61, second inner peripheral wall 62, second outer bottom wall 63, second outer peripheral wall 64, and base 65. Second inner bottom wall 61, second inner peripheral wall 62, second outer bottom wall 63, second outer peripheral wall 64, and base 65 are integrally formed.

Second inner bottom wall 61 has a rectangular plate shape elongated in third axis A3.

Second inner peripheral wall 62 protrudes upward from the peripheral edge of second inner bottom wall 61. Specifically, second inner peripheral wall 62 includes a pair of second inner walls 621 and four protruding walls 622. The pair of second inner walls 621 is a pair of walls elongated in third axis A3. The pair of second inner side walls 621 is provided at both ends of second inner bottom wall 61 in second axis A2 near the center in third axis A3 (a region between partial bottom walls of second outer bottom wall 63 described later). Four protruding walls 622 extend along third axis A3 from both ends of the pair of second inner walls 621 in third axis A3. Four protruding walls 622 protrude upward from second inner bottom wall 61 (bottom wall). Two of four protruding walls 622 face each other in second axis A2, and the remaining two of four protruding walls 622 face each other in second axis A2. Accommodation part 623 having a groove shape extending along first axis A1 is formed in one of two protruding walls 622 facing each other. Groove 624 having a groove shape extending along first axis A1 is formed in the other of two protruding walls 622 facing each other. In second housing 6, opening 66 penetrating the bottom wall (second inner bottom wall 61) in first axis A1 is formed in a region where accommodation part 623 and groove 624 face each other. The space in accommodation part 623, the space in groove 624, and opening 66 are connected to each other.

Base 65 has a rectangular parallelepiped shape elongated in third axis A3, and protrudes upward from the center of second inner bottom wall 61. The portion surrounded by the inner bottom surface of second inner bottom wall 61, the inner side surface of second inner peripheral wall 62, and the outer side surface of base 65 constitutes third fitting recess 601 into which first connector 1 is fitted. Specifically, first inner peripheral wall 22 of first connector 1 is fitted into third fitting recess 601.

Second outer bottom wall 63 includes four partial bottom walls extending in a rectangular shape in a plane orthogonal to first axis A1 from each of the four corners of second inner bottom wall 61.

Second outer peripheral wall 64 protrudes upward from the peripheral edge of second outer bottom wall 63 so as to surround second inner peripheral wall 62. Second outer peripheral wall 64 has a rectangular frame shape in which the central portion of each of the four sides is cut out in plan view. Second outer peripheral wall 64 extends in the circumferential direction.

The portion surrounded by the outer side surface of second inner peripheral wall 62, the inner bottom surface of second outer bottom wall 63, and the inner side surface of second outer peripheral wall 64 constitutes fourth fitting recess 602. First outer peripheral wall 24 of first connector 1 is fitted into fourth fitting recess 602 in a state where first connector 1 and second connector 5 are fitted.

Second housing 6 holds the plurality of second terminals 7 and second shield 8.

In the present exemplary embodiment, some (six) second terminals 7 (second connection terminals 72) of the plurality of (eight) second terminals 7 are provided across second inner wall 621 and base 65, respectively. Specifically, three second connection terminals 72 are provided on each of the pair of second inner walls 621. In the present exemplary embodiment, remaining second terminals 7 (second specific terminals 71) of the plurality of (eight) second terminals 7 are disposed between two protruding walls 622 facing in second axis A2.

In the present exemplary embodiment, second outer shield 81 of second shield 8 sandwiches second outer peripheral wall 64. In the present exemplary embodiment, second inner shield 85 of second shield 8 is disposed in groove hole 67 formed in second housing 6. Second inner shield 85 is formed integrally with second housing 6 by, for example, simultaneous molding.

### (2.2.2) Second Terminal

Second terminal 7 (terminal) is a signal transmission terminal, and is formed by bending a band-shaped metal plate. Second terminal 7 is plated with gold. The plurality of second terminals 7 are in contact with the plurality of first terminals 3 of first connector 1, respectively, in the fitted state in which first connector 1 and second connector 5 are fitted to each other.

The plurality of second terminals 7 include one or more second specific terminals 71. The plurality of second terminals 7 include one or more terminals (second connection terminals 72) other than second specific terminal 71. Here, among eight second terminals 7, two are second specific terminals 71, and the remaining six are second connection terminals 72.

Two second specific terminals 71 are disposed on both sides in third axis A3 in second connector 5. Each of two second specific terminals 71 is disposed between two protruding walls 622.

Six second connection terminals 72 are arranged side by side in third axis A3 in a region between two second specific terminals 71 in third axis A3 so as to be divided into three on each side in second axis A2. Three of six second connection terminals 72 are held on each of the pair of second inner walls 621.

For example, second specific terminal 71 is a terminal for transmitting a relatively high-frequency signal. Two second specific terminals 71 have the same shape. For example, a signal current flowing from first circuit board 91 to second circuit board 92 flows through one of two second specific terminals 71, and a signal current flowing from second circuit board 92 to first circuit board 91 flows through the other of two second specific terminals 71.

Second connection terminal 72 is a terminal for transmitting a relatively low-frequency signal. Some or all of the plurality of (for example, six) second connection terminals 72 may be terminals for transmitting power. Six second connection terminals 72 have the same shape. Second connection terminal 72 may include terminals having different shapes.

### (2.2.2.1) Second Specific Terminal

Second specific terminal 71 is connected to first specific terminal 31 by coming into contact with first specific terminal 31 (mating terminal) in the fitted state.

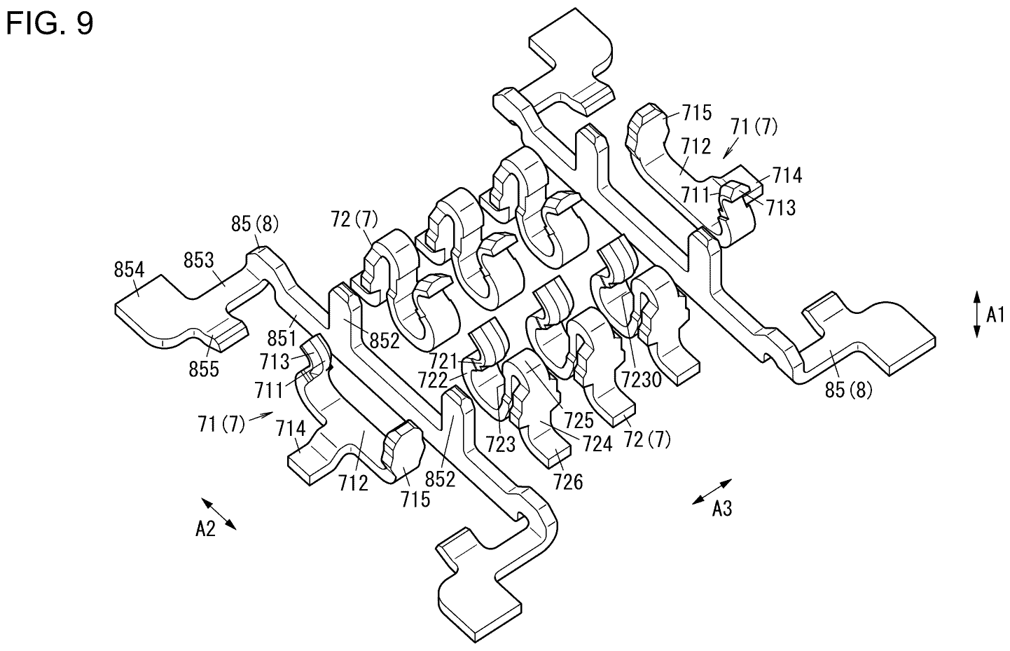

As illustrated in FIG. 9, second specific terminal 71 includes terminal piece 714, second contact piece 713, holding piece 715, and coupling piece 712, which are integrally formed.

Coupling piece 712 has a substantially rectangular flat plate shape having a thickness in first axis A1. Coupling piece 712 couples terminal piece 714, second contact piece 713, and holding piece 715. Specifically, second contact piece 713 is connected to the first end of coupling piece 712 in second axis A2, and holding piece 715 is connected to the second end of coupling piece 712 in second axis A2. Terminal piece 714 is connected to a side end of coupling piece 712 in third axis A3.

Terminal piece 714 has a substantially rectangular plate shape as viewed along first axis A1. Terminal piece 714 protrudes from coupling piece 712 along third axis A3. Terminal piece 714 is coupled to a portion of coupling piece 712 between a portion (first end in second axis A2) where second contact piece 713 is connected and a portion (second end in second axis A2) where holding piece 715 is connected. Terminal piece 714 includes a substantially rectangular flat plate-like portion (flat plate part) having a thickness in first axis A1, and a curved part that connects the flat plate part and coupling piece 712 while curving. Because of the curved part, the lower surface of the flat plate part of terminal piece 714 is positioned on the lower side of the lower surface of coupling piece 712. Terminal piece 714 (flat plate part) is configured to be connected to second circuit board 92.

Second contact piece 713 is a portion of second specific terminal 71 (terminal) that comes into contact with first specific terminal 31 (mating terminal). Second contact piece 713 protrudes upward from the first end of coupling piece 712 in second axis A2. Second contact piece 713 has second contact point 711 configured to come into contact with first specific terminal 31. Second specific terminal 71 is curved in a C shape as viewed along third axis A3, and a protruding end of the curved part is second contact point 711. Second contact point 711 is in contact with first contact point 315 of first contact piece 313.

Holding piece 715 is a portion held by second housing 6 in second specific terminal 71. As illustrated in FIG. 9, holding piece 715 has a substantially rectangular flat plate shape having a thickness in second axis A2. Holding piece 715 protrudes upward from the second end of coupling piece 712 in second axis A2. A pair of holding protrusions for second housing 6 to hold second specific terminal 71 is formed on end surfaces of holding piece 715 on both sides in third axis A3. Holding piece 715 is held in accommodation part 623 formed in protruding wall 622. Specifically, holding piece 715 is held by second housing 6 by press-fitting the pair of holding protrusions into the inner side surface of accommodation part 623 having a groove shape (see FIG. 1). Second contact piece 713 is accommodated in groove 624 in a state where holding piece 715 is held in accommodation part 623. Coupling piece 712 is disposed in opening 66 in a state where holding piece 715 is held in accommodation part 623. In a state where holding piece 715 is held in accommodation part 623, a portion (coupling piece 712, second contact piece 713, and terminal piece 714) of second specific terminal 71 other than holding piece 715 is not in contact with second housing 6 (a gap is formed). However, the present invention is not limited thereto, and a portion other than holding piece 715 of second specific terminal 71 may come into contact with second housing 6. Holding piece 715 is configured not to come into contact with (separate from) first specific terminal 31 in the fitted state in which first connector 1 and second connector 5 are fitted. Second contact piece 713 and holding piece 715 are disposed to face each other along second axis A2.

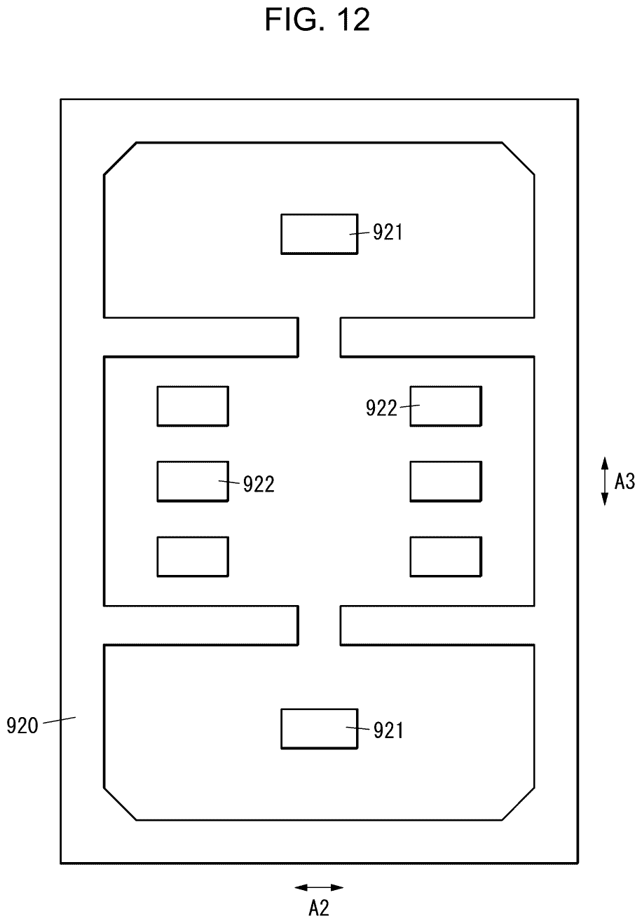

As illustrated in FIG. 16, second specific terminal 71 is connected to conductor pattern 921 (see FIG. 12) of second circuit board 92. Specifically, second specific terminal 71 is connected to conductor pattern 921 of second circuit board 92 on the lower surface (surface intersecting the thickness direction) of terminal piece 714.

### (2.2.2.2) Second Connection Terminal

As illustrated in FIG. 9, second connection terminal 72 includes contact piece 721, spring piece 722, rising piece 723, falling piece 724, connecting piece 725, and terminal piece 726, which are integrally formed. Contact piece 721 and rising piece 723 have contact points that come into contact with first connection terminal 32 in the fitted state.

Contact piece 721 has a plate shape having a thickness in second axis A2, and is curved in a C shape when viewed from third axis A3. The outer surface of contact piece 721 in second axis A2 is inclined such that both sides of contact piece 721 in second axis A2 become gradually thinner than the central portion. In the fitted state, contact piece 721 comes into contact with extending piece 321 of first connection terminal 32.

Spring piece 722 is formed in a U shape when viewed from third axis A3. Spring piece 722 is elastically deformed in second axis A2 so that the size of the upper opening changes. Because of the elastic force of spring piece 722, contact piece 721 elastically comes into contact with first connection terminal 32 in the fitted state.

Rising piece 723 has a substantially rectangular plate shape having a thickness in second axis A2. The lower end of rising piece 723 is connected to the upper end of spring piece 722. In the fitted state, rising piece 723 comes into contact with first connection terminal 32.

Rising piece 723 has step 7230 in the middle in the up-down directions. In the fitted state, the portion of rising piece 723 on the upper side than step 7230 comes into contact with contact piece 322 of first connection terminal 32.

Falling piece 724 has a substantially rectangular flat plate shape having a thickness in second axis A2. A pair of holding protrusions for second housing 6 to hold second connection terminal 72 is formed on both end surfaces of falling piece 724 in third axis A3.

Connecting piece 725 is curved in an inverted U shape so as to connect the upper end of rising piece 723 and the upper end of falling piece 724. Connecting piece 725 applies a repulsive force (elastic force) against the force along second axis A2 to second connection terminal 72.

Terminal piece 726 has a substantially rectangular flat plate shape having a thickness in first axis A1. Terminal piece 726 protrudes outward along second axis A2 from the lower end of falling piece 724. The lower surface of terminal piece 726 is exposed to the lower surface of second housing 6.

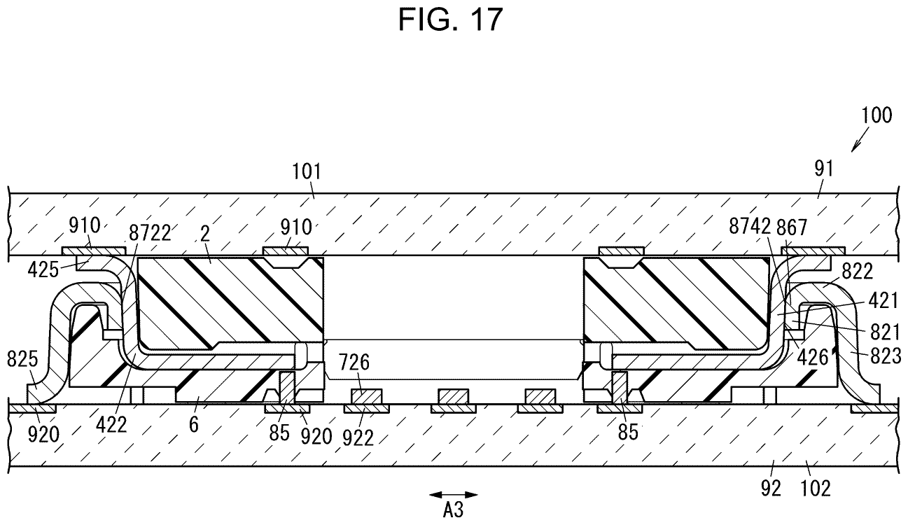

As illustrated in FIG. 17, second connection terminal 72 is connected to conductor pattern 922 (a conductor pattern different from conductor pattern 921 to which second specific terminal 71 is connected; see FIG. 12) of second circuit board 92. Specifically, second connection terminal 72 is connected to conductor pattern 922 of second circuit board 92 on the lower surface (surface intersecting the thickness direction) of terminal piece 726.

### (2.2.3) Second Shield

Second shield 8 is an electromagnetic shield for shielding electromagnetic waves. Second shield 8 reduces the influence of external noise (electromagnetic wave) on the signal current flowing through first terminal 3 and second terminal 7. In addition, second shield 8 reduces the influence of noise (electromagnetic wave) caused by the signal current flowing through first terminal 3 and second terminal 7 on an external electric device or the like. Second shield 8 is in contact with first shield 4 in the fitted state.

As illustrated in FIG. 1, second shield 8 surrounds at least one of the plurality of second terminals 7. Second shield 8 surrounds at least second specific terminal 71 among the plurality of second terminals 7. Here, second shield 8 surrounds the plurality of second specific terminals 71 and surrounds the plurality of second connection terminals 72.

The material of second shield 8 is selected from, for example, copper alloys such as phosphor bronze and corson copper, stainless steel, nickel silver, and the like.

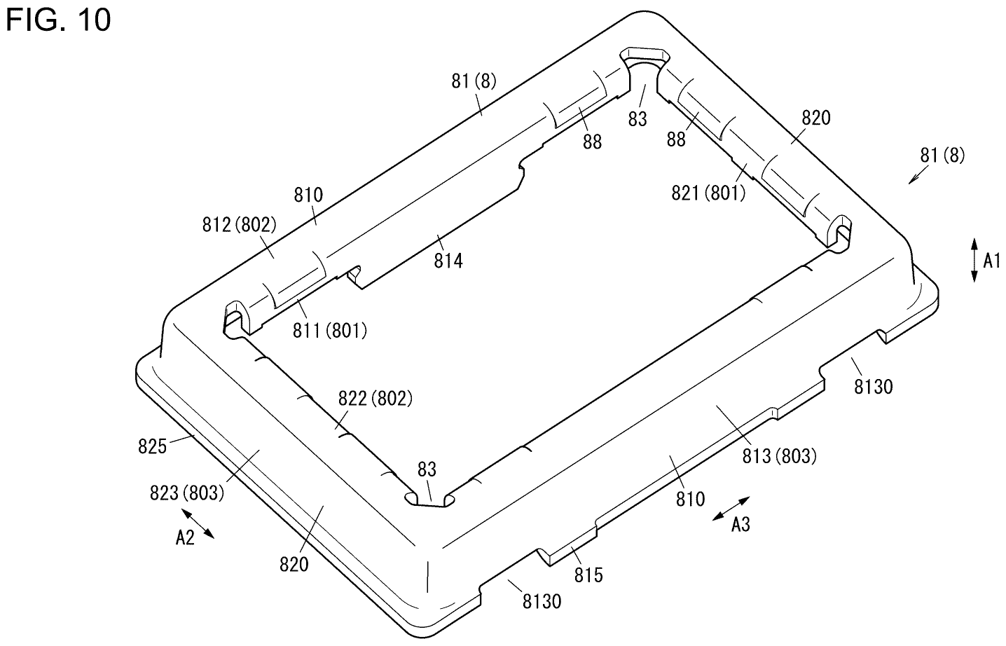

As illustrated in FIGS. 9 and 10, second shield 8 includes second outer shield 81 and second inner shield 85.

### (2.2.3.1) Second Outer Shield

As illustrated in FIG. 1, second outer shield 81 is held by second outer peripheral wall 64 of second housing 6. Second outer shield 81 surrounds the plurality of second terminals 7.

As illustrated in FIG. 10, second outer shield 81 includes a pair of second lateral shields 810 and a pair of second longitudinal shields 820.

The pair of second lateral shields 810 extends in the circumferential direction. As illustrated in FIG. 1, the pair of second lateral shields 810 extends in third axis A3. The pair of second lateral shields 810 covers the outer side surface of the side wall of second outer peripheral wall 64 along third axis A3. Each of the pair of second lateral shields 810 is provided across the side walls adjacent to each other in third axis A3. The pair of second lateral shields 810 covers the upper surface and the inner side surface of the side wall of second outer peripheral wall 64 along third axis A3.

The pair of second longitudinal shields 820 extends in the circumferential direction. As illustrated in FIG. 1, the pair of second vertical shields 820 extends in second axis A2. The pair of second longitudinal shields 820 covers the outer side surface of the side wall of second outer peripheral wall 64 along second axis A2. Each of the pair of second longitudinal shields 820 is provided across the side walls adjacent to each other in second axis A2. The pair of second longitudinal shields 820 covers the upper surface and the inner side surface of the side wall of second outer peripheral wall 64 along second axis A2.

The pair of second lateral shields 810 and the pair of second longitudinal shields 820 are integrally formed into a rectangular frame shape in plan view. Second outer shield 81 (the pair of second lateral shields 810 and the pair of second longitudinal shields 820) is formed by, for example, drawing. The end of second lateral shield 810 in third axis A3 and the end of second longitudinal shield 820 in second axis A2 are connected without any joint (seamlessly). Thus, second outer shield 81 seamlessly surrounds second terminal 7 in the circumferential direction. Cutout 83 is formed inside the corner where second lateral shield 810 and second longitudinal shield 820 are connected.

As illustrated in FIGS. 10, 11, 13A, and 13B, second lateral shield 810 includes second side wall 811, second coupling part 812, fourth side wall 813, extension part 814, and junction 815.

Second side wall 811 has a rectangular flat plate shape having a thickness in second axis A2. Second side wall 811 extends in first axis A1 (up-down directions). Second side wall 811 extends in third axis A3. Second side wall 811 has inner facing part 866.

Fourth side wall 813 has a plate shape having a thickness in second axis A2. Fourth side wall 813 is positioned outside second side wall 811 in second axis A2 and faces second side wall 811. Fourth side wall 813 is provided over the entire length of second lateral shield 810 in third axis A3. Fourth side wall 813 has outer facing part 896. Outer facing part 896 and inner facing part 866 face each other with an interval in second axis A2.

Second coupling part 812 couples second side wall 811 and fourth side wall 813. Second coupling part 812 couples the upper end of second side wall 811 and the upper end of fourth side wall 813.

As illustrated in FIG. 13A, second coupling part 812 includes inner coupling part 816, upper coupling part 818, and outer coupling part 819.

Upper coupling part 818 has a flat plate shape extending along third axis A3 and having a thickness in first axis A1. Upper coupling part 818 connects inner coupling part 816 and outer coupling part 819. Upper coupling part 818 covers the upper surface of second outer peripheral wall 64 of second housing 6. The lower end of upper coupling part 818 faces a space between inner facing part 866 and outer facing part 896.

Inner coupling part 816 connects upper coupling part 818 and second side wall 811. Inner coupling part 816 is connected to inner facing part 866. In FIG. 13A, inner coupling part 816 is located above imaginary line M1, and inner facing part 866 (second side wall 811) is located below imaginary line M1. Inner coupling part 816 has inner curved part 861.

As illustrated in FIG. 13A, inner curved part 861 is curved so as to bulge toward the inside of second connector 5. Inner curved part 861 is curved downward from the inner end of upper coupling part 818 in second axis A2. The lower end of inner curved part 861 is connected to the upper end of inner facing part 866.

Outer coupling part 819 connects upper coupling part 818 and fourth side wall 813. Outer coupling part 819 is connected to outer facing part 896. In FIG. 13A, a portion above imaginary line M1 is outer coupling part 819, and a portion below imaginary line M1 is outer facing part 896 (fourth side wall 813). Outer coupling part 819 has outer curved part 891.

As illustrated in FIG. 13A, outer curved part 891 is curved so as to bulge toward the outside of second connector 5. Outer curved part 891 is curved downward from the outer end of upper coupling part 818 in second axis A2. The lower end of outer curved part 891 is connected to the upper end of outer facing part 896.

Inner curved part 861 and outer curved part 891 are disposed in second axis A2 via upper coupling part 818.

Inner facing part 866 of second side wall 811 is disposed below inner coupling part 816. Inner facing part 866 faces outer facing part 896 with a space therebetween in second axis A2 (see FIG. 13A). Inner facing part 866 faces outer facing part 896 in second axis A2 without interposing upper coupling part 818 therebetween. Inner facing part 866 faces outer facing part 896 via the space or second housing 6 (second outer peripheral wall 64). The upper end of inner facing part 866 is connected to inner curved part 861.

Outer facing part 896 of fourth side wall 813 is disposed below outer coupling part 819. Outer facing part 896 faces inner facing part 866 with a space therebetween in second axis A2 (see FIG. 13A). The upper end of outer facing part 896 is connected to outer curved part 891.

As illustrated in FIG. 13A, second side wall 811, second coupling part 812, and fourth side wall 813 are connected in an inverted U shape so as to protrude upward from first axis A1 as viewed from third axis A3.

As illustrated in FIGS. 10 and 11, second lateral shield 810 has protrusion 88 on its outer surface. Protrusion 88 is formed one by one at both ends of second lateral shield 810 in third axis A3 (portions corresponding to portions of first lateral shield 410 where recessed parts 47 are formed). Protrusion 88 will be described later.

As illustrated in FIGS. 11 and 13A, second side wall 811 has inclined surface 845 at the lower end away from second coupling part 812. Inclined surface 845 is inclined such that the thickness of second side wall 811 decreases toward the lower end. Inclined surface 845 is formed at a position below protrusion 88.

As illustrated in FIG. 10, extension part 814 has a plate shape having a thickness in second axis A2. Extension part 814 protrudes downward from the central portion at the lower end of second side wall 811 in third axis A3. Extension part 814 faces fourth side wall 813 in second axis A2. A pair of holding protrusions for second housing 6 to hold second lateral shield 810 is formed on both end surfaces of extension part 814 in third axis A3. Second outer shield 81 is held by second housing 6 by inserting (press-fitting) extension part 814 into the cutout portion of second outer peripheral wall 64 in second housing 6.

Junction 815 is curved from the lower end of fourth side wall 813 to the outside in second axis A2. Junction 815 extends from a central portion and both end portions at the lower end of fourth side wall 813 in third axis A3. At the lower end of fourth side wall 813, rectangular cutout 8130 is formed in a portion where junction 815 is not provided. As illustrated in FIGS. 18 and 19, the lower surface of junction 815 is connected to ground pattern 920 (see FIG. 12) of second circuit board 92.

Second outer peripheral wall 64 of second housing 6 is disposed between second side wall 811 and fourth side wall 813.

When viewed from second axis A2, second side wall 811 and extension part 814 of second lateral shield 810 and fourth side wall 813 face each other outside second connection terminal 72. Thus, in second axis A2, second connection terminal 72 is doubly shielded by second side wall 811 and extension part 814, and fourth side wall 813.

As illustrated in FIG. 10, second longitudinal shield 820 includes second side wall 821, second coupling part 822, fourth side wall 823, and junction 825.

Second side wall 821 has a rectangular flat plate shape having a thickness in third axis A3. Second side wall 821 extends in first axis A1 (up-down directions). Second side wall 821 extends in second axis A2. Second side wall 821 has inner facing part 867.

Fourth side wall 823 has a plate shape having a thickness in third axis A3. Fourth side wall 823 is positioned outside second side wall 821 in third axis A3 and faces second side wall 821. Fourth side wall 823 is provided over the entire length of second longitudinal shield 820 in second axis A2. Fourth side wall 823 of second longitudinal shield 820 is connected to fourth side wall 813 of second lateral shield 810 without any joint (seamlessly). Fourth side wall 823 has outer facing part 897. Outer facing part 897 and inner facing part 867 face each other at an interval in third axis A3.

Second coupling part 822 couples second side wall 821 and fourth side wall 823. Second coupling part 822 couples the upper end of second side wall 821 and the upper end of fourth side wall 823. Second coupling part 822 of second longitudinal shield 820 is connected to second coupling part 812 of second lateral shield 810 without any joint (seamlessly).

As illustrated in FIG. 13B, second coupling part 822 includes inner coupling part 826, upper coupling part 828, and outer coupling part 829.

Upper coupling part 828 has a flat plate shape extending along second axis A2 and having a thickness in first axis A1. Upper coupling part 828 connects inner coupling part 826 and outer coupling part 829. Upper coupling part 828 covers the upper surface of second outer peripheral wall 64 of second housing 6. The lower end of upper coupling part 828 faces a space between inner facing part 867 and outer facing part 897.

Inner coupling part 826 connects upper coupling part 828 and second side wall 821. Inner coupling part 826 is connected to inner facing part 867. In FIG. 13B, inner coupling part 826 is located above imaginary line M2, and inner facing part 867 (second side wall 821) is located below imaginary line M2. Inner coupling part 826 has inner curved part 862.

As illustrated in FIG. 13B, inner curved part 862 is curved so as to bulge toward the inside of second connector 5. Inner curved part 862 is curved downward from the inner end of upper coupling part 828 in third axis A3. The lower end of inner curved part 862 is connected to the upper end of inner facing part 867.

Outer coupling part 829 connects upper coupling part 828 and fourth side wall 823. Outer coupling part 829 is connected to outer facing part 897. In FIG. 13B, outer coupling part 829 is located above imaginary line M2, and the outer facing part 897 (fourth side wall 823) is located below imaginary line M2. Outer coupling part 829 has outer curved part 892.

As illustrated in FIG. 13B, outer curved part 892 is curved so as to bulge toward the outside of second connector 5. Outer curved part 892 is curved downward from the outer end of upper coupling part 828 in third axis A3. The lower end of outer curved part 892 is connected to the upper end of outer facing part 897.

Inner curved part 862 and outer curved part 892 are disposed in third axis A3 via upper coupling part 828.

Inner facing part 867 of second side wall 821 is disposed below inner coupling part 826. Inner facing part 867 faces outer facing part 897 with a space therebetween in third axis A3 (see FIG. 13B). Inner facing part 867 faces outer facing part 897 in third axis A3 without interposing upper coupling part 828 therebetween. Inner facing part 867 faces outer facing part 897 via a space or second housing 6 (second outer peripheral wall 64). The upper end of inner facing part 867 is connected to inner curved part 862.

Outer facing part 897 of fourth side wall 823 is disposed below outer coupling part 829. Outer facing part 897 faces inner facing part 867 with a space therebetween in third axis A3 (see FIG. 13B). The upper end of outer facing part 897 is connected to outer curved part 892.

As illustrated in FIG. 13B, second side wall 821, second coupling part 822, and fourth side wall 823 are connected in an inverted U shape so as to protrude upward from first axis A1 as viewed from second axis A2.

As illustrated in FIGS. 10 and 11, second longitudinal shield 820 has protrusion 88 on its outer surface. One protrusion 88 is formed on each of one side and the other side (a portion corresponding to the portion where recessed part 47 is formed in first longitudinal shield 820) of the center of second longitudinal shield 420 in second axis A2. Protrusion 88 will be described later.

As illustrated in FIGS. 11 and 13B, second side wall 821 has inclined surface 845 at the lower end away from second coupling part 822. Inclined surface 845 is inclined such that the thickness of second side wall 821 decreases toward the lower end. Inclined surface 845 is formed at a position below protrusion 88.

Junction 825 is coupled to the lower end of fourth side wall 823. Junction 825 is curved from the lower end of fourth side wall 823 to the outside in third axis A3. Junction 825 is provided over the entire length of second longitudinal shield 820 in second axis A2. As illustrated in FIGS. 14 to 17, the lower surface of junction 825 is connected to ground pattern 920 (see FIG. 12) of second circuit board 92.

Second outer peripheral wall 64 of second housing 6 is disposed between second side wall 821 and fourth side wall 823.

As described above, second lateral shield 810 and second longitudinal shield 820 have protrusion 88 on the outer surface thereof. Hereinafter, for convenience, second side walls 811 and 821 will be collectively referred to as inner wall 801 without distinction, fourth side walls 813 and 823 will be collectively referred to as outer wall 803 without distinction, and second coupling parts 812 and 822 will be collectively referred to as coupling part 802 without distinction. Inner coupling parts 816 and 826 are collectively referred to as inner coupling part 806 without distinction, outer coupling parts 819 and 829 are collectively referred to as outer coupling part 809 without distinction, and upper coupling parts 818 and 828 are collectively referred to as upper coupling part 808 without distinction. Inner curved parts 861 and 862 are collectively referred to as inner curved part 860 without distinction, and inner facing parts 866 and 867 are collectively referred to as inner facing part 865 without distinction. Outer curved parts 891 and 892 are collectively referred to as outer curved part 890 without distinction, and outer facing parts 896 and 897 are collectively referred to as outer facing part 895 without distinction.

As illustrated in FIG. 11, protrusion 88 protrudes so as to rise slightly from the periphery. The protruding amount of protrusion 88 gradually increases toward the inside of the second connector 5. The protruding amount of protrusion 88 gradually increases downward. As illustrated in FIGS. 11, 13A, and 13B, the protruding end (lower end) of protrusion 88 is inclined surface 89. Further, the thickness of the outer surface below protrusion 88, that is, the thickness of the outer surface of inner wall 801 continuous downward with inclined surface 89 is smaller than the thickness of protrusion 88.

Protrusion 88 is formed at least on an outer surface of coupling part 802. Protrusion 88 is formed on an outer surface of a portion corresponding to at least inner curved part 860. In the present exemplary embodiment, protrusion 88 is formed over the outer surface of inner curved part 860 and the outer surface of inner facing part 865.

In other words, as illustrated in FIG. 11, the outer surface of inner curved part 860 has first portion 871 and second portion 872. Second portion 872 is continuous with first portion 871 via a step in the circumferential direction. When first portion 871 and second portion 872 of second lateral shield 810 are referred to as first portion 8711 and second portion 8721, respectively, second portion 8721 is continuous with first portion 8711 via a step in the direction along third axis A3. When first portion 871 and second portion 872 of second longitudinal shield 820 are referred to as first portion 8712 and second portion 8722, respectively, second portion 8722 is continuous with first portion 8712 via a step in the direction along second axis A2.

First portion 871 is a curved surface. Second portion 872 is a curved surface having a curvature radius smaller than that of first portion 871. First portion 871 is a portion corresponding to protrusion 88, and protrudes more inward of second connector 5 than second portion 872. Second portions 872 is provided on both sides of first portion 871 in the circumferential direction. Second portion 872 is located between two first portions 871 in the circumferential direction.

First portion 8711 is formed on an outer surface of inner curved part 861 intersecting a straight line passing through upper coupling part 818 and along second axis A2.

First portion 8712 is formed on an outer surface of inner curved part 862 intersecting a straight line passing through upper coupling part 828 and along third axis A3.

The maximum thickness of the portion of inner curved part 860 corresponding to first portion 871 is larger than the maximum thickness of the portion of inner curved part 860 corresponding to second portion 872.

As illustrated in FIG. 11, the outer surface of inner facing part 865 has third portion 873 and fourth portion 874. Third portion 873 is continuous with first portion 871. Third portion 873 is continuous with first portion 871 in the curving direction in which first portion 871 is curved. Fourth portion 874 is continuous with second portion 872. Fourth portion 874 is continuous with second portion 872 in the curving direction in which second portion 872 is curved. Fourth portion 874 is continuous with third portion 873 via a step in the circumferential direction. When third portion 873 and fourth portion 874 of second lateral shield 810 are referred to as third portion 8731 and fourth portion 8741, respectively, fourth portion 8741 is continuous with third portion 8731 via a step in the direction along third axis A3. When third portion 873 and fourth portion 874 of second longitudinal shield 820 are referred to as third portion 8732 and fourth portion 8742, respectively, fourth portion 8742 is continuous with third portion 8732 via a step in the direction along second axis A2.

Third portion 873 is a curved surface. Fourth portion 874 is a plane. However, the present invention is not limited thereto, and at least a part of third portion 873 (a lower end portion of third portion 873) may be a plane, or at least a part of fourth portion 874 (an upper end portion of fourth portion 874) may be a curved surface. Third portion 873 is a portion corresponding to protrusion 88, and protrudes more inward of second connector 5 than fourth portion 874. Fourth portion 874 is provided on both sides of third portion 873 in the circumferential direction. Fourth portion 874 is located between two third portions 873 in the circumferential direction. The maximum thickness of the portion of inner facing part 865 corresponding to third portion 873 is larger than the maximum thickness of the portion of inner facing part 865 corresponding to fourth portion 874.

Protrusion 88 includes a portion corresponding to first portion 871 in inner curved part 860 and a portion corresponding to third portion 873 in inner facing part 865.

Protrusion 88 is formed, for example, by rolling (stretching while applying pressure) a portion other than protrusion 88 out of inner coupling part 806 and inner wall 801. Thus, the thickness (L1, L3) of the portion other than protrusion 88 out of inner coupling part 806 and inner wall 801 is smaller (L1<L2, L3<L4) than the thickness (L2, L4) of the portion of second outer shield 81 not subjected to the rolling processing, for example, outer wall 803. The thickness of the portion of second outer shield 81 not subjected to the rolling processing is substantially constant. For example, the thickness (thickness of the portion corresponding to first portion 871 and thickness of the portion corresponding to third portion 873) of the portion of inner coupling part 806 corresponding to protrusion 88 is substantially the same as the thickness (L2, L4) of outer wall 803.

### (2.2.3.2) Second Inner Shield

Second inner shield 85 is disposed between two second terminals 7 among the plurality of second terminals 7. Here, second inner shield 85 is disposed between second specific terminal 71 and second connection terminal 72.

As illustrated in FIGS. 1 and 9, in the present exemplary embodiment, second shield 8 includes two second inner shields 85. Two second inner shields 85 are disposed side by side in third axis A3 so as to partition between one second specific terminal 71 and the plurality of (six) second connection terminals 72 and between the plurality of second connection terminals 72 and another second specific terminal 71.

In this manner, since second inner shield 85 is disposed between two second specific terminals 71, it is possible to reduce the influence of noise caused by the signal current flowing through one second specific terminal 71 on the signal current flowing through the other second specific terminal 71 and second connection terminal 72. That is, insulation (isolation) between two second specific terminals 71 can be improved.

As illustrated in FIG. 9, second inner shield 85 includes main piece 851, a pair of support pieces 852, a pair of extending pieces 853, a pair of terminal pieces 854, and a pair of holding pieces 855.

Main piece 851 has a rectangular plate shape that has a thickness in third axis A3 and is long in second axis A2. Each of the pair of support pieces 852 has a plate shape having a thickness in third axis A3. The pair of support pieces 852 extends upward from the upper end surface of main piece 851 with a space in second axis A2. Each of the pair of extending pieces 853 has a plate shape having a thickness in first axis A1. The pair of extending pieces 853 extends from both ends of main piece 851 on second axis A2 toward the outside of third axis A3. The pair of terminal pieces 854 has a plate shape having a thickness in first axis A1. The pair of terminal pieces 854 extends from the tips of the pair of extending pieces 853 toward the outside of second axis A2. The pair of holding pieces 855 has a plate shape extending obliquely upward toward the inside of second axis A2 from a middle portion of the pair of extending pieces 853 in third axis A3.

As illustrated in FIGS. 1 and 14 to 17, second inner shield 85 is fixed to second housing 6. The lower surface of main piece 851 is exposed from the lower surface of second housing 6, and the inner end surfaces of the pair of support pieces 852 in second axis A2 are exposed to third fitting recess 601.

As illustrated in FIG. 1, terminal piece 854 extends to the outside of second outer peripheral wall 64 of second housing 6 in plan view. Terminal piece 854 is located below cutout 8130 of second outer shield 81. Terminal piece 854 extends to the outside of second outer shield 81 as viewed from first axis A1. The lower surface of terminal piece 854 is connected to ground pattern 920 (see FIG. 12) of second circuit board 92.

In this manner, in second shield 8, second inner shield 85 separate from second outer shield 81 includes terminal piece 854 connected to ground pattern 920 of the circuit board (second circuit board 92). Terminal piece 854 is disposed below the lower end of second outer shield 81. This facilitates connection work (for example, soldering or the like) of second inner shield 85 to ground pattern 920.

Here, in a state where second shield 8 is not connected to ground pattern 920 of second circuit board 92, second outer shield 81 and second inner shield 85 are separated from each other and are not electrically connected to each other. As illustrated in FIG. 19, the upper surface of first inner shield 45 (main piece 451) is connected to ground pattern 910 of first circuit board 91, and the lower surface of second inner shield 85 (main piece 851) is connected to ground pattern 920 of second circuit board 92.

### (2.3) Connection Device

As illustrated in FIGS. 14 to 19, first connector 1 is connected to first circuit board 91. First connector 1 and first circuit board 91 constitute first connection device (mating connection device) 101. That is, first connection device 101 includes first connector 1 and first circuit board 91 to which first connector 1 is connected. Second connector 5 is connected to second circuit board 92. Second connector 5 and second circuit board 92 constitute second connection device (connection device) 102. That is, second connection device 102 includes second connector 5 and second circuit board 92 to which second connector 5 is connected.

### (2.3.1) First Connection Device

In first connection device 101, (terminal pieces 312 of) two first specific terminals 31 of first connector 1 are respectively joined to two conductor patterns 911 of first circuit board 91 by, for example, solder (see FIG. 16). In addition, (terminal pieces 324 of) six first connection terminals 32 of first connector 1 are respectively joined to six conductor patterns 912 of first circuit board 91 by, for example, solder (see FIG. 15). Further, main pieces 451 of two first inner shields 45 of first connector 1 are joined to ground pattern 910 of first circuit board 91 by, for example, solder (see FIGS. 15 and 19), and junctions 415 and 425 of first outer shield 41 are joined to ground pattern 910 of first circuit board 91 by, for example, solder (see FIGS. 15 to 19).

In first connector 1, terminal piece 312 of first specific terminal 31 is disposed at the center between the pair of first lateral shields 410 as viewed along first axis A1. That is, terminal pieces 312 are disposed at symmetrical positions in second axis A2. Consequently, the degree of freedom in wiring design of first circuit board 91 to which first connector 1 is connected is improved, and first connection device 101 can be downsized.

### (2.3.2) Second Connection Device

In second connection device 102, (terminal pieces 714 of) two second specific terminals 71 of second connector 5 are respectively joined to two conductor patterns 921 of second circuit board 92 by, for example, solder (see FIG. 16). In addition, (terminal pieces 726 of) six second connection terminals 72 of second connector 5 are respectively joined to six conductor patterns 922 of second circuit board 92 by solder, for example (see FIG. 17). Further, main pieces 851 and terminal pieces 854 of two second inner shields 85 of second connector 5 are joined to the ground pattern 920 of second circuit board 92 by, for example, solder (see FIGS. 15, 17, and 19), and junctions 815 and 825 of second outer shield 81 are joined to ground pattern 920 of second circuit board 92 by, for example, solder (see FIGS. 15 to 19).

In second connector 5, terminal piece 714 of second specific terminal 71 is disposed at the center between the pair of second lateral shields 810 as viewed along first axis A1. That is, terminal pieces 714 are disposed at symmetrical positions in second axis A2. Consequently, the degree of freedom in wiring design of second circuit board 92 to which second connector 5 is connected is improved, and second connection device 102 can be downsized.

### (2.4) Connector Assembly

The structure of connector assembly 100 in which first connector 1 and second connector 5 are fitted will be described with reference to FIGS. 1, 2, and 14 to 19. As illustrated in FIGS. 1 and 14, first connector 1 (mating connector) is to be fitted from above second connector 5 (connector).

### (2.4.1) Connection of Terminals

In the fitted state, two first specific terminals 31 of first connector 1 are in contact with and electrically connected to two second specific terminals 71 of second connector 5, respectively. Consequently, signals can be transmitted and received between first circuit board 91 on which first connector 1 is mounted and second circuit board 92 on which second connector 5 is mounted via first specific terminal 31 and second specific terminal 71. As illustrated in FIG. 18, in the fitted state, first contact piece 313 of first specific terminal 31 and second contact piece 713 of second specific terminal 71 are in contact with each other. Specifically, in the fitted state, first contact point 315 on the outer surface of first contact piece 313 of first specific terminal 31 in second axis A2 comes into contact with second contact point 711 of second contact piece 713 of second specific terminal 71.

In the fitted state, holding piece 715 of second specific terminal 71 is separated from first specific terminal 31 without being in contact with first specific terminal 31. Coupling piece 314 of first specific terminal 31 faces coupling piece 712 of second specific terminal 71. Coupling piece 314 of first specific terminal 31 and coupling piece 712 of second specific terminal 71 are separated from each other without being in contact with each other. The lower surface of coupling piece 314 of first specific terminal 31 and the upper surface of coupling piece 712 of second specific terminal 71 are parallel to each other. In the fitted state, first specific terminal 31 and second specific terminal 71 are in contact with each other only at one place (first contact point 315 and second contact point 711). The contact pressure between first contact point 315 and second contact point 711 is secured by the elastic force or the like of second contact piece 713 of second specific terminal 71.

In connector assembly 100 of the present exemplary embodiment, second specific terminal 71 of second connector 5 (connector) comes into contact with first specific terminal 31 of first connector 1 (mating connector) only at one place (second contact point 711). Thus, it is possible to suppress the fluctuation of the characteristic impedance along the path of the current while ensuring the connection reliability between the terminals. Since the fluctuation of the characteristic impedance is suppressed, the loss due to the reflection of the high-frequency signal can be reduced.

In the fitted state, six first connection terminals 32 of first connector 1 are in contact with and electrically connected to six second connection terminals 72 of second connector 5, respectively. Consequently, signals can be transmitted and received between first circuit board 91 on which first connector 1 is mounted and second circuit board 92 on which second connector 5 is mounted via first connection terminal 32 and second connection terminal 72.

Specifically, first connection terminal 32 is in contact with second connection terminal 72 on the inner surface of extending piece 321 (surface intersecting the thickness direction) in second axis A2 and on the outer surface of contact piece 322 (surface intersecting the thickness direction) in second axis A2. In addition, second connection terminal 72 is in contact with first connection terminal 32 on the inner surface of contact piece 721 (surface intersecting the thickness direction) in second axis A2 and on the outer surface of rising piece 723 (surface intersecting the thickness direction) in second axis A2.

More specifically, extending piece 321, contact piece 322, and connecting piece 323 of first connection terminal 72 are inserted between contact piece 721 of second connection terminal 32 and rising piece 723. Then, contact piece 721 comes into contact with depression 3210 of extending piece 321. Consequently, second connection terminal 72 comes into contact with first connection terminal 32 so as to sandwich first connection terminal 32 between contact piece 721 and rising piece 723. By the elastic force or the like of spring piece 722 of second connection terminal 72, the contact pressure between extending piece 321 and contact piece 721 is secured, and the contact pressure between contact piece 322 and rising piece 723 is secured.

### (2.4.2) Connection of Shield

In the fitted state, first outer shield 41 of first connector 1 is in contact with and electrically connected to second outer shield 81 of second connector 5. In the fitted state, first inner shield 45 of first connector 1 is in contact with and electrically connected to second inner shield 85 of second connector 5. Consequently, the potentials of first shield 4 and second shield 8 become the same ground potential.

As illustrated in FIGS. 15 to 19, in the fitted state, at least one of the outer surface of inner coupling part 806 (816, 826) and the outer surface of inner wall 801 (second side wall 811, 821) of second outer shield 81 is in contact with first outer shield 41. Here, both the outer surface of inner coupling part 806 (816, 826) and the outer surface of inner wall 801 (second side wall 811, 821) of second outer shield 81 are in contact with first outer shield 41.

More specifically, as illustrated in FIGS. 15 and 18, in the fitted state, third portion 873 (8731, 8732) of the outer surface of inner facing part 865 (866, 867) of inner wall 801 (second side wall 811, 821) comes into contact with recessed surface 407 (417, 427) of first outer shield 41. As illustrated in FIGS. 16, 17, and 19, in the fitted state, fourth portion 874 (8741, 8742) of the outer surface of inner facing part 865 (866, 867) of inner wall 801 (second side wall 811, 821) comes into contact with reference surface 406 (416,426) of first outer shield 41.

As illustrated in FIGS. 15 and 18, in the fitted state, the lower end portion (portion near the boundary with third portion 873) of first portion 871 (8711, 8712) of the outer surface of inner curved part 860 (861, 862) in coupling part 802 (812, 822) comes into contact with recessed surface 407 (417, 427) of first outer shield 41. As illustrated in FIGS. 16, 17, and 19, in the fitted state, the lower end portion (portion near the boundary with fourth portion 874) of second portion 872 (8721, 8722) of the outer surface of inner curved part 860 (861, 862) in coupling part 802 (812, 822) comes into contact with reference surface 406 (416, 426) of first outer shield 41.

In other words, in the fitted state, at least one (here, both) of the first surface and the second surface comes into contact with first outer shield 41. The first surface includes first portion 871 and a portion (third portion 873) continuous with first portion 871 (8711, 8712) without a step in inner facing part 865 (866, 867). The second surface includes second portion 872 and a portion (fourth portion 874 continuous with second portion 872 (8721, 8722) without a step in inner facing part 865 (866, 867). In the present exemplary embodiment, in the fitted state, the outer surface of second outer shield 81 comes into contact with first outer shield 41. Specifically, in the fitted state, at least one (here, both) of first portion 871 and second portion 872 of second outer shield 81 comes into contact with first outer shield 41. In the fitted state, at least one (here, both) of third portion 873 and fourth portion 874 of second outer shield 81 is in contact with first outer shield 41. First portion 871 may be separated without being in contact with first outer shield 41, and second portion 872 may be separated without being in contact with first outer shield 41.

Further, as illustrated in FIGS. 16, 17, and 19, in the fitted state, an outer surface of a portion of inner wall 801 (second side wall 811,821) below inner facing part 865 (866, 867) comes into contact with reference surface 406 (416, 426) of first outer shield 41.

When viewed from the viewpoint of first connector 1 (mating connector), the outer surface of (first side wall 401 of) first outer shield 41 has reference surface 406 (416, 426) and recessed surface 407 (417, 427). In the fitted state, second outer shield 81 (shield) is in contact with at least one (here, both) of reference surface 406 and recessed surface 407. In the present exemplary embodiment, in the fitted state, third portion 873 of the outer surface of inner facing part 865 of second outer shield 81 is in contact with recessed surface 407, and fourth portion 874 of the outer surface of inner facing part 865 of second outer shield 81 and the outer surface of inner wall 801 are in contact with reference surface 406. In the fitted state, first portion 871 of second outer shield 81 is in contact with recessed surface 407, and second portion 872 is in contact with reference surface 406.

In the fitted state, at least one of first portion 871 of inner curved part 860 of second outer shield 81 and third portion 873 of inner facing part 865 is in linear contact with recessed surface 407 of first outer shield 41, and more preferably in planar contact with the recessed surface. In the fitted state, at least one of second portion 872 of inner curved part 860 of second outer shield 81 and fourth portion 874 of inner facing part 865 is in linear contact with reference surface 406 of first outer shield 41, and more preferably in planar contact with the reference surface. Further, the outer surface of the portion of inner wall 801 of second outer shield 81 on the lower side with respect to inner facing part 865 is in linear contact with reference surface 406 of first outer shield 41, and more preferably in planar contact with the reference surface. Preferably, first lateral shield 410 of first outer shield 41 and second lateral shield 810 of second outer shield 81 are in contact with each other without discontinuities along third axis A3 between cutouts 83 of second outer shield 81. Preferably, first longitudinal shield 420 of first outer shield 41 and second longitudinal shield 820 of second outer shield 81 are in contact with each other without discontinuities along second axis A2 between cutouts 83 of second outer shield 81. In the fitted state, a shield can be continuously formed by first outer shield 41 and second outer shield 81. This can improve the shielding property against electromagnetic waves.

To fit first connector 1 to second connector 5, first connector 1 is positioned above second connector 5 as illustrated in FIGS. 1 and 14. When first connector 1 is moved downward from this state, the portion of first side wall 401 of first outer shield 41 on the lower side with respect to recessed part 47 in reference surface 416 comes into contact with protrusion 88 (at least one of first portion 871 and third portion 873) of inner wall 801 of second outer shield 81. Consequently, first side wall 401 of first outer shield 41 bends inward, and inner wall 801 of second outer shield 81 bends outward.

When first connector 1 is further moved downward from here, protrusion 88 enters recessed part 47, and first side wall 401 and inner wall 801 return to their original shapes. At this time, protrusion 88 collides with recessed surface 407, and a so-called clicking feeling is given to the user gripping first outer shield 41. Thus, the user can easily grasp that first connector 1 and second connector 5 are fitted.

In the fitted state in which first connector 1 and second connector 5 are fitted (see FIGS. 15 to 19), a shield is formed by first outer shield 41 and second outer shield 81 so as to surround the plurality of first terminals 3 and the plurality of second terminals 7. In the fitted state, in the space between first circuit board 91 and second circuit board 92, all of the plurality of first terminals 3 and the plurality of second terminals 7 are surrounded by the shield formed of first shield 4 and second shield 8 without any gap over the entire circumference. This can improve the shielding property against electromagnetic waves. In particular, in the space between first circuit board 91 and second circuit board 92, it is preferable that first specific terminal 31 and second specific terminal 71 for transmitting a high-frequency signal are surrounded by the shield formed of first shield 4 and second shield 8 without a gap over the entire circumference.

In addition, as illustrated in FIG. 19, in connector assembly 100 of the present exemplary embodiment, in the fitted state, the end surface along the thickness direction of first inner shield 45 (the end surface intersecting second axis A2) and the end surface along the thickness direction of second inner shield 85 are in contact with each other. This can improve the shielding property against electromagnetic waves.

In the fitted state, protrusion 88 that has entered recessed part 47 is caught by the edge portion of recessed part 47, and thus first connector 1 is less likely to come off from second connector 5. This can prevent the fitting state from being unintentionally released.

To detach second connector 5 from first connector 1, first connector 1 is moved upward from the state of FIGS. 15 to 19. Consequently, protrusion 88 of second outer shield 81 moves relatively downward in recessed part 47 of first outer shield 41, and the lower end of protrusion 88 comes into contact with the edge portion of recessed part 47.

When first connector 1 is further moved upward from here, protrusion 88 moves across the edge portion of recessed part 47 to the outside of recessed part 47. Consequently, first side wall 401 of first outer shield 41 bends inward, and inner wall 801 of second outer shield 81 bends outward. Here, in connector assembly 100 of the present exemplary embodiment, since inclined surface 89 is formed at the lower end of protrusion 88, and inclined surface 419 is formed at the edge portion of recessed part 47, protrusion 88 is not excessively caught by the edge portion of recessed part 47. Thus, by applying a large force to some extent, first connector 1 can be smoothly detached from second connector 5. In addition, since inclined surface 845 is formed at the lower end of inner wall 801 of second outer shield 81, it is also possible to prevent the edge portion of recessed part 47 from being caught at the lower end of inner wall 801. In particular, inclined surface 845 of inner wall 801 of second outer shield 81 is located on the upper side with respect to the lower end of first outer shield 41 in the fitted state (see FIGS. 15 and 18). Consequently, the lower end of inner wall 801 of second outer shield 81 is prevented from being caught by the edge portion of recessed part 47, and first connector 1 can be smoothly detached from second connector 5.

When first connector 1 is further moved upward, protrusion 88 is detached from the outer surface of first side wall 401, first side wall 401 and inner wall 801 are returned to the original shapes, and first connector 1 is detached from second connector 5.

### (3) Modifications

The exemplary embodiments of the present disclosure are not limited to the above exemplary embodiment. The above exemplary embodiment can be variously changed in accordance with design and the like as long as the object of the present disclosure can be achieved. Hereinafter, modifications of the above-described exemplary embodiment will be listed. The modifications described below can be applied in appropriate combination.

### (3.1) First Modification

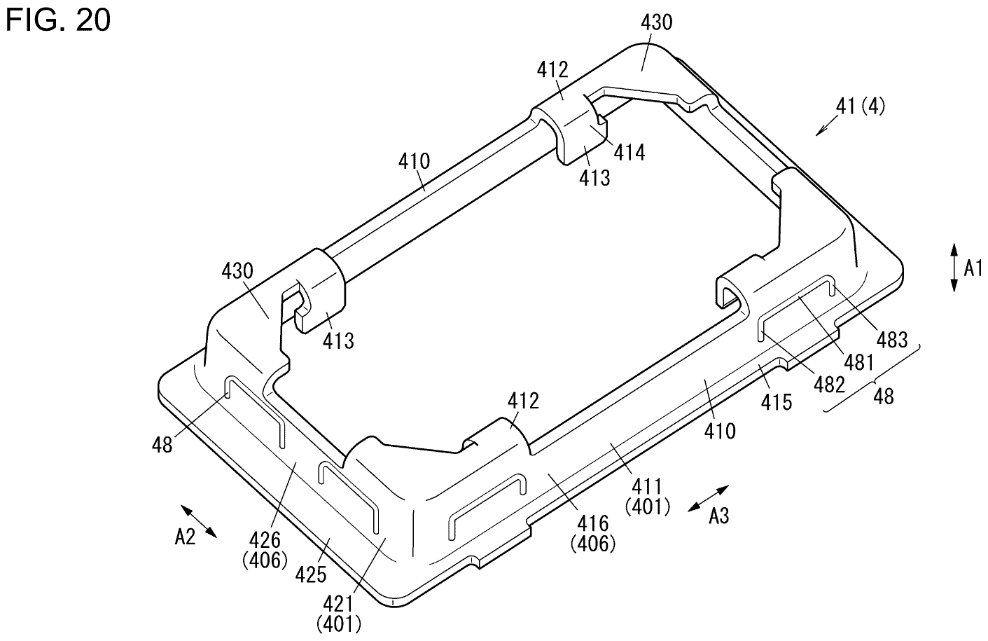

Connector assembly 100 of a first modification will be described with reference to FIG. 20. Connector assembly 100 of the present modification is different from connector assembly 100 of the exemplary embodiment in first outer shield 41 (mating shield) of first connector 1 (mating connector). In connector assembly 100 of the present modification, the same reference numerals are given to the same configurations as those of connector assembly 100 of the exemplary embodiment, and the description thereof is appropriately omitted.

As illustrated in FIG. 20, the outer surface of first outer shield 41 of first connector 1 (mating connector) of the present modification includes reference surface 416 and protrusion 48 protruding from reference surface 416. Protrusion 48 protrudes from reference surface 416 in a semicircular section in the thickness direction of first side wall 401, for example. As illustrated in FIG. 20, protrusion 48 includes, for example, first portion 481 extending along first side wall 401, and second portion 482 and third portion 483 extending upward (downward in FIG. 20) from both ends of first portion 481, and the protrusion has a U shape when viewed along a direction orthogonal to first axis A1. Protrusion 48 is formed at a position corresponding to protrusion 88 in second outer shield 81 of second connector 5 (connector) (position where recessed part 47 is provided in first outer shield 41 of the exemplary embodiment).

In the fitted state, first portion 481 of protrusion 48 is located below protrusion 88 of second outer shield 81. Then, first portion 481 of protrusion 48 of first outer shield 41 comes into contact with the outer surface of inner wall 801 of second outer shield 81. The tip of protrusion 88 of second outer shield 81 (at least one of first portion 871 and third portion 873) comes into contact with a region surrounded on three sides by protrusion 48 on reference surface 406 of first side wall 401 of first outer shield 41. In this manner, in connector assembly 100 of the present modification, second outer shield 81 (shield) comes into contact with at least one (here, both) of reference surface 406 and protrusion 48 in the fitted state.

Also in the present modification, it is possible to prevent the fitting state between second connector 5 (connector) and first connector 1 (mating connector) from being unintentionally released, and it is easy to maintain the fitting state between first connector 1 and second connector 5.

### (3.2) Second Modification

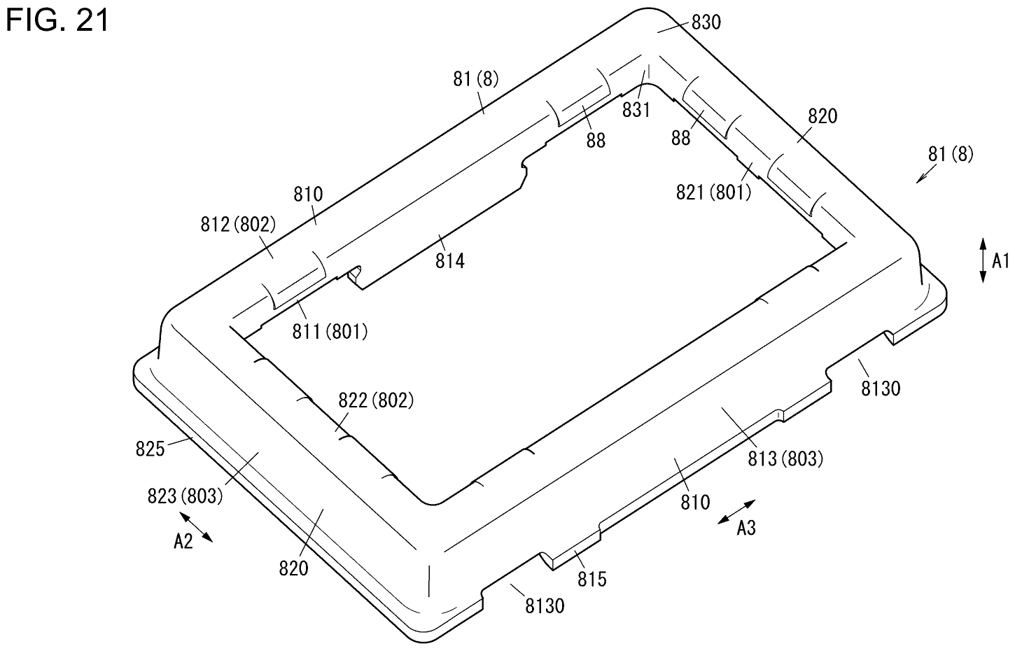

Connector assembly 100 of a second modification will be described with reference to FIG. 21. Connector assembly 100 of the present modification is different from connector assembly 100 of the exemplary embodiment in second outer shield 81 (shield) of second connector 5 (connector). In connector assembly 100 of the present modification, the same reference numerals are given to the same configurations as those of connector assembly 100 of the exemplary embodiment, and the description thereof is appropriately omitted.

As illustrated in FIG. 21, second outer shield 81 of second connector 5 (connector) of the present modification is formed in a substantially rectangular shape having corner 830 at which second lateral shield 810 and second longitudinal shield 820 are coupled as viewed along first axis A1 (up-down directions).

Second side wall 811 of second lateral shield 810 and second side wall 821 of second longitudinal shield 820 are connected in the circumferential direction at corner 830 via connecting part 831. Consequently, second side wall 811 of second lateral shield 810 and second side wall portion 821 of second longitudinal shield 820 are formed seamlessly in the circumferential direction. In addition, second coupling part 812 of second lateral shield 810 and second coupling part 822 of second longitudinal shield 820 are formed seamlessly in the circumferential direction. Further, fourth side wall 813 of second lateral shield 810 and fourth side wall 823 of second longitudinal shield 820 are formed seamlessly in the circumferential direction. In short, in the present modification, second lateral shield 810 and second longitudinal shield 820 are formed seamlessly from the inner wall to the outer wall in the circumferential direction at corner 830.

Also in the present modification, in the fitted state, a shield can be continuously formed by first outer shield 41 and second outer shield 81. This can improve the shielding property against electromagnetic waves.

### (3.3) Other Modifications

In one modification, second outer shield 81 (and/or first outer shield 41) does not have to surround the entire circumference of second terminal 7 (first terminal 3). For example, second outer shield 81 may have a shape surrounding three sides of second terminal 7 (a C shape as viewed along first axis A1).

In one modification, second outer shield 81 (and/or first outer shield 41) may be configured by combining a plurality of members. For example, second outer shield 81 may be configured by combining two members having an L shape as viewed along first axis A1.

In one modification, the protrusion 88 does not have to be formed on inner facing part 865, but it may be formed only on inner curved part 860. That is, third portion 873 does not have to be provided.

### Conclusions

As described above, a connector according to a first aspect (second connector 5) is a connector to be fitted to a mating connector (first connector 1), the mating connector including a mating shield (first outer shield 41). The connector includes a housing (second housing 6), a terminal (second terminal 7), and a shield (second outer shield 81). The terminal is held by the housing. The shield is held by the housing, and the shield surrounds the terminal in a circumferential direction. The shield is configured to come into contact with the mating shield in a fitted state in which the connector and the mating connector are fitted to each other. The connector is configured to be connected to the mating connector by moving toward the mating connector. The shield includes outer wall (803),
inner wall (801), and coupling part (802). Outer wall (803) includes outer facing part (895). Inner wall (801) includes inner facing part (865). Inner wall (801) is located inside with respect to outer wall (803). Coupling part (802) couples outer wall (803) and inner wall (801). Coupling part (802) includes inner coupling part (806) connected to inner facing part (865), outer coupling part (809) connected to outer facing part (895), and upper coupling part (808) connecting inner coupling part (806) and outer coupling part (809). Inner coupling part (806) includes inner curved part (860) curved and bulging toward an inner side of the connector. Outer coupling part (809) includes outer curved part (890) curved and bulging toward an outer side of the connector. Inner curved part (860) and outer curved part (890) are connected via upper coupling part (808). Outer facing part (895) and inner facing part (865) face each other with a space between the outer facing part and the inner facing part. an outer surface of inner curved part (860) includes first portion (871) and second portion (872). Second portion (872) is continuous with first portion (871). A step is formed by first portion (871) and second portion (872). A part of first portion (871) is located inside the connector with respect to second portion (872).

According to this aspect, it is possible to obtain a connector that can easily maintain a fitted state with a mating connector.

In the connector according to a second aspect, the outer surface of inner curved part (860) is configured to be in contact with the mating shield in the fitted state.

According to this aspect, the shield comes into contact with the mating shield, whereby the shielding property against electromagnetic waves can be improved.

In the connector according to a third aspect, first portion (871) or second portion (872) is configured to be in contact with the mating shield in the fitted state.

According to this aspect, the shield comes into contact with the mating shield, whereby the shielding property against electromagnetic waves can be improved.

In the connector according to a fourth aspect, inner facing part (865) includes a first surface or a second surface that comes into contact with the mating shield in the fitted state. The first surface includes first portion (871) and third portion (873) continuous with first portion (871) without a step. The second surface includes second portion (872) and fourth portion (874) continuous with second portion (872) without a step. A part of third portion (873) is located inside the connector with respect to fourth portion (874).

According to this aspect, the first surface and/or the second surface comes into contact with the mating shield, whereby the shielding property against electromagnetic waves can be improved.

In the connector according to a fifth aspect, third portion (873) or fourth portion (874) is configured to come into contact with the mating shield in the fitted state.

According to this aspect, third portion (873) and/or fourth portion (874) comes into contact with the mating shield, whereby the shielding property against electromagnetic waves can be improved.

In the connector according to a sixth aspect, an outer surface of the mating shield includes reference surface (406) and recessed surface (407) depressed from reference surface (406). The shield is configured to come into contact with reference surface (406) or recessed surface (407) in the fitted state.

According to this aspect, the shield comes into contact with reference surface (406) and/or recessed surface (407), whereby the shielding property against electromagnetic waves can be improved. In addition, since the shield comes into contact with recessed surface (407), it is easy to maintain the fitted state with the mating connector.

In the connector according to a seventh aspect, an outer surface of the mating shield includes reference surface (406) and protrusion (48) protruding from reference surface (406). The shield is configured to come into contact with reference surface (406) or protrusion (48) in the fitted state.

According to this aspect, the shield comes into contact with reference surface (406) and/or protrusion (48), whereby the shielding property against electromagnetic waves can be improved. In addition, since the shield comes into contact with reference surface (406) on the lower side of protrusion (48), it is easy to maintain the fitted state with the mating connector.

In the connector according to an eighth aspect, in any one the first to seventh aspect, a maximum thickness of a portion corresponding to first portion (871) in inner curved part (860) is larger than a maximum thickness of a portion corresponding to second portion (872) in inner curved part (860).

According to this aspect, first portion (871) can be manufactured by rolling, and it is possible to prevent a decrease in shielding properties and to simplify the process.

In the connector according to a ninth aspect, inner wall (801) includes inclined surface (845) at an end away from coupling part (802).

According to this aspect, when the connector is detached from the mating connector, the connector can be smoothly detached.

In the connector according to a tenth aspect, inclined surface (845) of inner wall (801) of the shield is configured to be located above a lower end with respect to the mating shield in the fitted state.

According to this aspect, when the connector is detached from the mating connector, the connector can be smoothly detached.

In the connector according to an eleventh aspect, the shield seamlessly surrounds the terminal in the circumferential direction.

According to this aspect, it is possible to improve the shielding property against electromagnetic waves.

In the connector according to a twelfth aspect, the mating connector further includes a mating terminal (first terminal 3) configured to be connected to the terminal of the connector in the fitted state. The mating shield seamlessly surrounds the mating terminal in the circumferential direction.

According to this aspect, it is possible to improve the shielding property against electromagnetic waves.

A connector assembly according to a thirteenth aspect includes the connector according to any one of the first to twelfth aspect and the mating connector.

According to this aspect, it is possible to obtain a connector assembly that easily maintains a fitted state between a connector and a mating connector.

A connection device (second connection device 102) according to a fourteenth aspect includes the connector according to any one of the first to thirteenth aspect and a circuit board (second circuit board 92) to which the connector is connected.

According to this aspect, it is possible to obtain a connection device including a connector that easily maintains a fitted state with a mating connector.

### REFERENCE MARKS IN THE DRAWINGS

1: first connector (mating connector)
101: First connection device
102: second connection device (connection device)
2: First housing
3: first terminal (mating terminal)
32: First connection terminal
4: First shield
401, 411, 421: first side wall
406, 416, 426: reference surface
407, 417: recessed surface
409, 419, 429: inclined surface
41: first outer shield (mating shield)
410: first lateral shield
412: first coupling part
415: junction
420: first longitudinal shield
422: first coupling part
425: junction
427: recessed surface
48: protrusion
5: second connector (connector)
6: second housing (housing)
61: second inner bottom wall
62: second inner peripheral wall
63: second outer bottom wall
64: second outer peripheral wall
65: base
7: second terminal (terminal)
72: Second connection terminal
8: Second shield
801: inner wall
802: coupling part
803: outer wall
806, 816: inner coupling part
808, 818: upper coupling part
809, 819: outer coupling part
81: second outer shield (shield)
810: second lateral shield
811, 821: second side wall
812, 822: second coupling part
813, 823: fourth side wall
814: extension part
815, 825: junction
826: inner coupling part
828: upper coupling part
829: outer coupling part
845: inclined surface
860, 861, 862: inner curved part
865, 866, 867: inner facing part
871, 8711, 8712: first portion
872, 8721, 8722: second portion
873, 8731, 8732: third portion
874, 8741, 8742: fourth portion
89: inclined surface
890, 891, 892: outer curved part
895, 896: outer facing part
897: outer facing part
91: first circuit board
92: second circuit board (circuit board)
A1: first axis

1. A connector to be fitted to a mating connector, the mating connector including a mating shield, the connector comprising:
a housing;
a terminal held by the housing; and
a shield held by the housing, the shield surrounding the terminal in a circumferential direction, the shield being configured to come into contact with the mating shield in a fitted state in which the connector and the mating connector are fitted to each other,
wherein the connector is configured to be connected to the mating connector by moving toward the mating connector,
the shield includes:
an outer wall including an outer facing part;
an inner wall including an inner facing part and positioned inside the connector with respect to the outer wall; and
a coupling part coupling the outer wall and the inner wall,
the coupling part includes:
an inner coupling part including an inner curved part curved and bulging toward an inner side of the connector, the inner coupling part being connected to the inner facing part;
an outer coupling part including an outer curved part curved and bulging toward an outer side of the connector, the outer coupling part being connected to the outer facing part; and
an upper coupling part connecting the inner coupling part and the outer coupling part,
the inner curved part and the outer curved part are connected via the upper coupling part,
the outer facing part and the inner facing part face each other with a space between the outer facing part and the inner facing part,
an outer surface of the inner curved part includes:
a first portion; and
a second portion continuous with the first portion,
a step is formed by the first portion and the second portion, and
a part of the first portion is located inside the connector with respect to the second portion.

2. The connector according to claim 1, wherein the outer surface of the inner curved part is configured to be in contact with the mating shield in the fitted state.

3. The connector according to claim 2, wherein the first portion or the second portion is configured to be in contact with the mating shield in the fitted state.

4. The connector according to claim 1, wherein
the inner facing part includes a first surface or a second surface that comes into contact with the mating shield in the fitted state,
the first surface includes the first portion and a third portion continuous with the first portion without a step,
the second surface includes the second portion and a fourth portion continuous with the second portion without a step, and
a part of the third portion is located inside the connector with respect to the fourth portion.

5. The connector according to claim 4, wherein the third portion or the fourth portion is configured to come into contact with the mating shield in the fitted state.

6. The connector according to claim 2, wherein
an outer surface of the mating shield includes a reference surface and a recessed surface depressed from the reference surface, and
the shield is configured to come into contact with the reference surface or the recessed surface in the fitted state.

7. The connector according to claim 2, wherein
an outer surface of the mating shield includes a reference surface and a protrusion protruding from the reference surface, and
the shield is configured to come into contact with the reference surface or the protrusion in the fitted state.

8. The connector according to claim 1, wherein a maximum thickness of a portion corresponding to the first portion in the inner curved part is larger than a maximum thickness of a portion corresponding to the second portion in the inner curved part.

9. The connector according to claim 1, wherein the inner wall includes an inclined surface at an end away from the coupling part.

10. The connector according to claim 9, wherein the inclined surface of the inner wall is configured to be located above a lower end with respect to the mating shield in the fitted state.

11. The connector according to claim 1, wherein the shield seamlessly surrounds the terminal in the circumferential direction.

12. The connector according to claim 1, wherein
the mating connector further includes a mating terminal configured to be connected to the terminal of the connector in the fitted state, and
the mating shield seamlessly surrounds the mating terminal in the circumferential direction.

13. A connector assembly comprising:
the connector according to claim 1; and
the mating connector.

14. A connection device comprising:
the connector according to claim 1; and
a circuit board to which the connector is connected.
